(19) United States
(12) Patent Application Publication
(10) Pub. No.: US 2014/0287100 A1
(43) Pub. Date: Sep. 25, 2014

(54) CONTROLLING RF APPLICATION IN ABSENCE OF FEEDBACK

(71) Applicant: Avner Libman, Holon (IL)

(72) Inventor: Avner Libman, Holon (IL)

(73) Assignee: GOJI LTD., Hamilton (BM)

(21) Appl. No.: 14/236,243

(22) PCT Filed: Aug. 6, 2012
(86) PCT No.: PCT/IB2012/001866

§ 371 Date: Mar. 18, 2014

Related U.S. Application Data
(60) Provisional application No. 61/522,427, filed on Aug. 11, 2011.

(51) Int. Cl. H05B 6/64; B65D 81/34

(52) U.S. Cl. CPC H05B 6/6441; B65D 81/3446
USPC 426/87; 219/702

(57) ABSTRACT

An apparatus for applying electromagnetic energy to an object in a first energy application zone via at least one radiating element is disclosed. The apparatus may include at least one processor configured to cause the at least one radiating element to apply energy to the energy application zone at two or more MSEs; and adjust energy supplied to the at least one radiating element to follow changes in an MSE-dependent parameter, in absence of feedback from the energy application zone regarding the MSE-dependent parameter, based on data having been collected during energy application in a second energy application zone before the object is placed in the first energy application zone.

### CLAIM OF PRIORITY

This PCT International Patent Application claims priority to U.S. Provisional Patent Application No. 61/522,427, filed on Aug. 11, 2011, which is incorporated herein by reference in its entirety.

### DESCRIPTION

1. Field of the Technology

The present technology concerns devices that may apply microwave or RF energy to objects in an energy application zone, and more particularly, but not exclusively, in the field of controlling such devices in absence of certain kinds of feedback from the energy application zone.

2. Background

Electromagnetic waves have been used in various applications to supply energy to objects. In the case of radio frequency (RF) radiation for example, electromagnetic energy may be supplied using a magnetron, which is typically tuned to a single frequency for supplying electromagnetic energy only in that frequency. One example of a commonly used device for supplying electromagnetic energy is a microwave oven. Typical microwave ovens supply electromagnetic energy at or about a single frequency of 2.45 GHz.

Some microwave ovens may be controlled by a user to operate for a given period (for example, 30 seconds) at a certain power level (for example, 80% of full power). Microwave ovens that may be controlled based on codes entered by the user, for example, using a keypad, are also known.

### SUMMARY

An aspect of some embodiments of the disclosed technology may include a system comprising an apparatus for applying RF energy to an object, and an object. In some embodiments, the object may be associated with a code; and the apparatus may include an interface for receiving the code and a processor configured to decode the code to operation instructions of the apparatus.

In some embodiments, the operation instructions may be such that carrying out the operating instructions causes changes in a control parameter to be followed during the operation (e.g., during energy application) in absence of feedback regarding the changes.

In some embodiments, the operation instructions may be such that when carried out, changes that occur in a control parameter during the operation are followed in absence of feedback regarding the changes.

An aspect of some embodiments of the disclosed technology may include an apparatus for applying electromagnetic energy to an object in an energy application zone via at least one radiating element.

In some embodiments, the apparatus may comprise at least one processor configured to adjust energy supplied to the at least one radiating element, according to data relating to a value indicative of energy absorbable by the object at at least one MSE.

In some embodiments, the processor may be configured to adjust energy supplied to the at least one radiating element, according to data relating to an MSE-dependent control parameter.

In some embodiments, the data may have been collected before the object is placed in the energy application zone. Additionally, or alternatively, the data may have been collected during energy application at another apparatus, for example, at a different energy application zone.

In some embodiments, the at least one processor may be configured to adjust energy supplied to the at least one radiating element such that the energy supplied is inversely related to an absorbable energy value over a range of MSEs based on data having been collected before the object is placed in the energy application zone.

In some embodiments, the at least one processor may be configured to cause the at least one radiating element to supply energy to the energy application zone at two or more MSEs; and adjust the energy supplied to follow changes in an MSE-dependent parameter based on data having been collected before the object is placed in the energy application zone. Additionally or alternatively, the data may be collected when energy is applied at another apparatus, for example, to another object, which may be an exemplar of the object treated by the current apparatus.

In some embodiments, the at least one processor may be configured to determine a target amount of energy to be absorbed by the object; and adjust energy supplied to the at least one radiating element, based on data having been collected before the object is placed in the energy application zone. The energy may be supplied such that the target amount of energy is absorbed by the object.

In some embodiments, the at least one processor may be configured to adjust energy supplied to the at least one radiating element, such that an amount of the supplied energy follows changes in a control parameter, based on data having been collected before the object was placed in the energy application zone.

In some embodiments, the at least one processor may be configured to adjust amounts of energy supplied to at least one of the radiating elements, such that the supplied amounts follow changes in a control parameter, wherein the processor is configured to adjust the amounts of energy in absence of feedback regarding the control parameter, and based on data gathered before the object was placed in the energy application zone.

In some embodiments, the at least one processor may be configured to cause electromagnetic energy to be supplied to the at least one radiating element at a plurality of MSEs. In some embodiments, amount of energy supplied to the at least one radiating element at each particular MSE of the plurality of MSEs may be a function of an MSE dependent parameter. In addition, the processor may be configured to cause the electromagnetic energy to be supplied in the absence of feedback from the object regarding the value of the MSE dependent parameter and based on data gathered before the object was placed in the energy application zone.

In some embodiments, supplying energy at two or more of the MSEs in the plurality of MSEs causes the development of mutually different field patterns in the energy application zone.

In some embodiments, the at least one processor may be configured to cause the one or more radiating elements to excite in the energy application zone a plurality of different field patterns; and adjust amounts of energy supplied to the energy application zone at each of the field patterns, such that the amount of energy supplied at each field pattern follow changes in a control parameter associated with the field pattern. In addition, the at least one processor may be configured to adjust the amounts of energy in absence of feedback regarding the control parameter at the plurality of field patterns, and based on data gathered before the object was placed in the energy application zone.

In some embodiments, the at least one processor may be configured to adjust energy supplied to the at least one radiating element, such that when the energy supplied is plotted along with an absorbable energy value over a range of MSEs, the two plots tend to mirror each other. In some embodiments, the at least one processor may be further configured to adjust the energy supplied to the at least one radiating element in absence of feedback from the object regarding amounts of energy absorbable in or reflected from the energy application zone, and based on data gathered before the object was placed in the energy application zone.

In some embodiments, the at least one processor may be configured to cause one or more of the radiating elements to supply energy to the energy application zone at two or more MSEs; and adjust amounts of energy supplied at each of the MSEs, to follow changes in an MSE dependent parameter. In some embodiments, the at least one processor may be configured to adjust the amounts of energy in absence of feedback regarding the values of the MSE dependent parameter. This may be done, for example, based on data gathered before the object was placed in the energy application zone. The data may have been gathered when another object (which may be an exemplar of the object treated by the current apparatus) was processed in another apparatus.

In some embodiments, the at least one processor may be configured to cause energy to be supplied to the at least one radiating element in a plurality of MSEs, in the absence of feedback regarding amounts of energy absorbed in or reflected from the energy application zone and based on data gathered before the object was placed in the energy application zone. In some embodiments, energy supplied to the at least one radiating element at each particular MSE of the plurality of MSEs may be inversely related to the energy absorbable by the object at the particular MSE.

In some embodiments, the at least one processor may be configured to determine a target amount of energy to be absorbed by the object; and adjust energy supplied to the at least one radiating element, in the absence of feedback regarding amounts of energy absorbed in or reflected from the energy application zone such that the target amount of energy is absorbed by the object. This may be done based on data gathered before the object was placed in the energy application zone,

In some embodiments, the at least one processor may be configured to adjust the energy supplied to the at least one radiating element twice or more during energy application to the object.

For example, the processor may be configured to adjust the energy supplied to the at least one radiating element between 1 and 15 times per minute.

In some embodiments, the at least one processor may be configured to adjust energy supplied in absence of feedback from the energy application zone regarding the value indicative of energy absorbable by the object.

In some embodiments, the value indicative of energy absorbable by the object represents results of a measurement of an exemplar of the object.

In some embodiments, the value indicative of energy absorbable by the object may include a dissipation ratio, for example, it may be a dissipation ratio.

In some embodiments, the energy supplied may vary inversely with the value indicative of energy absorbable by the object.

In some embodiments, the data relates to at least one of amounts of incident, reflected, or coupled energies. In some embodiments, the data relates to coupled energies.

In some embodiments, the apparatus may include an interface configured to receive the data.

In some embodiments, the interface may include a reader configured to read a machine readable element.

In some embodiments, the machine readable element may be associated with the object.

In some embodiments, the apparatus may be configured to adjust the amounts of energy supplied to at least one of the radiating elements according to the data.

In some embodiments, the apparatus may include a reader configured to read data from machine readable elements, and the at least one processor may be configured to receive data read by the reader, and cause the electromagnetic energy to be supplied to the at least one radiating element according to the data.

In some embodiments, the apparatus may include a reader configured to read the code from machine readable elements and obtain the data from a data source, based on the code. The data source may be internal or external to the apparatus. For example, the data source may be a storage device accessible to the apparatus. The storage device may include a memory on the apparatus. Alternatively or additionally the storage device may include a server accessible to the device, e.g., through the Internet.

In some embodiments, the interface may include at least one of a keypad, touch screen, cable or wireless connection.

In some embodiments, the apparatus may include a reader configured to read the data from machine readable elements, and the at least one processor may be configured to receive the data from the reader.

In some embodiments, adjusting energy supplied may be such that more energy is supplied when the value indicative of energy absorbable by the object is smaller than a threshold than when the value indicative of energy absorbable by the object is larger than the threshold.

In some embodiments, adjusting energy supplied may be such that the energy supplied varies inversely to the value indicative of energy absorbable by the object over a range of MSEs.

In some embodiments, adjusting energy supplied may be such that more than two different amounts of energy are supplied.

In some embodiments, the data may be indicative of expected changes in the control parameter.

In some embodiments, the data may be indicative of amounts of energy to be supplied in order to follow changes in the control parameter.

In some embodiments, the data may be based on feedback indicative of energy absorbable by a benchmark object, and the data may have been collected during the heating of the benchmark object.

In some embodiments, the at least one processor may be configured to adjust the amount of energy supplied to at least one of the radiating elements such that at MSEs where a value indicative of energy absorbable by the object is smaller than a threshold, more energy is supplied than at MSEs wherein the value indicative of energy absorbable by the object is larger than the threshold. For example, in some embodiments, when the energy supplied is plotted along with a value indicative of energy absorbable by the object over a range of MSEs, the two plots tend to mirror each other.

In some embodiments, more than two different amounts of energy may be supplied to a radiating element, each at a different range of a value indicative of energy absorbable by the object.

An aspect of some embodiments of the disclosed technology may include a packaged product, comprising:

a first food item packed for consumer use; and

a machine readable element associated with the first food item.

In some embodiments, the machine readable element may carry data produced as the result of exposing a second food item to electromagnetic energy at different MSEs for a period, and measuring values indicative of energy absorbable in the second food item at the different MSEs.

In some embodiments, the machine readable element may carry data collected when a second food item was exposed to electromagnetic energy at different MSEs.

In some embodiments, the machine readable element may carry a code which may correlate to data collected when a second food item was exposed to electromagnetic energy at different MSEs. The data may be accessed remotely by the code.

In some embodiments, the data may be indicative of weights to be associated with different MSEs.

In some embodiments, the data may be indicative of values of one or more control parameters at different times along said period.

In some embodiments, the data may allow exposing the first food item to electromagnetic energy such that a change in a control parameter is followed during the exposing.

In some embodiments, the control parameter may be MSE dependent.

For example, in some embodiments, the control parameter may be a value indicative of energy absorbable in the first food item. Optionally or alternatively, the control parameter may be a dissipation ratio.

An aspect of some embodiments of the disclosed technology may include a method of applying electromagnetic energy to an object placed in an energy application zone via at least one radiating element.

In some embodiments, the method may include adjusting energy supplied to the at least one radiating element, such that an amount of the supplied energy follows changes in a control parameter, based on data having been collected before the object was placed in the energy application zone.

In some embodiments, the method may include adjusting amounts of energy supplied to at least one of the radiating elements, such that the supplied amounts follow changes in a control parameter. The adjusting may be in absence of feedback from the object regarding the control parameter, and based on data gathered before the object was placed in the energy application zone.

In some embodiments, the method may include reading, from a machine readable element, information indicative of amounts of energy to be supplied to at least one of the radiating elements in each of a plurality of MSEs; and supplying energy to a radiating element according to the read information.

An aspect of some embodiments of the disclosed technology may include a method comprising heating a first object with electromagnetic energy according to feedback regarding an MSE dependent control parameter; and recording information regarding the heating process to a machine readable element, wherein the recorded information is sufficient to reproduce the heating process in absence of feedback regarding the MSE dependent control parameter. In some embodiments, the information may be recorded on a storage (e.g., memory) and a code (e.g., an identification number—tag ID) may be recorded on the machine readable element which may correspond (e.g., allow access) to the information recorded on the memory.

In some embodiments, the control parameter may be indicative of amounts of energy absorbable by the object.

In some embodiments, the control parameter may be MSE-dependent.

In some embodiments, the control parameter may depend on at least one of an amount of incident, reflected, or coupled energy, for example, on coupled energy.

In some embodiments, the data may be indicative of expected changes in the control parameter.

In some embodiments, the data may be indicative of amounts of energy to be supplied in order to follow changes in the control parameter.

In some embodiments, the data may be based on feedback indicative of energy absorbable by a benchmark object, and wherein the data has been collected during the heating of the benchmark object.

In some embodiments, the method may include substantially reproducing the heating process for a second object using the information.

In some embodiments, substantially reproducing the heating process comprises adjusting energy supplied to a second object such that the energy supplied varies inversely with a dissipation ratio over a range of MSEs.

In some embodiments, the information includes information relating to changes in the MSE dependent control parameter for the first object during heating. For example, the recorded information may include information relating to changes that took place in the MSE dependent control parameter during the heating of the first object.

In some embodiments, the method may include receiving data indicative of expected changes in the control parameter; and supplying energy to the at least one of the radiating elements based on the data indicative of expected changes.

In some embodiments, the method may include receiving data indicative of amounts of energy to be supplied in order to follow changes in the parameter indicative of amount of energy absorbable by the object; and supplying the energy as indicated by the received data.

In some embodiments, the method may include supplying energy to at least one radiating element to heat a benchmark object based on feedback indicative of values of a parameter indicative of amounts of energy absorbable by the benchmark object, and wherein the adjusting in the absence of feedback from the object is based on data gathered during the heating of the benchmark object.

### BRIEF DESCRIPTION OF THE DRAWINGS

FIG. 1 is a diagrammatic representation of an apparatus for applying electromagnetic energy to an object, in accordance with some exemplary embodiments of the present invention;

FIG. 2 is a view of a cavity, in accordance with some exemplary embodiments of the present invention;

FIG. 3 is a representation of an exemplary modulation space, in accordance with some exemplary embodiments of the present invention;

FIG. 4A is a graphical representation of two different control parameters as functions of MSE (frequency) and energy that may be supplied to a radiating element according to a heating protocol that follows one of the control parameters according to some embodiments of the invention;

FIG. 4B is a graphical representation of a heating protocol according to some embodiments of the present invention;

FIG. 4C is a graph showing dissipation ratios measured during heating of pizza in a feedback-based oven one and two minutes after heating commencement;

FIG. 4D is a graph showing incident energies that follow changes in the dissipation ratios shown in FIG. 4C, according to some embodiments of the invention

FIG. 5A is a diagrammatic representation of an apparatus for applying electromagnetic energy to an object, in accordance with some exemplary embodiments of the present invention;

FIG. 5B provides a diagrammatic representation of an exemplary feedback-based apparatus 100B for applying electromagnetic energy to an object;

FIG. 6 is a flow chart of a method for applying electromagnetic energy to an energy application zone in accordance with some embodiments of the present invention;

FIG. 7 is a flow chart of a method for applying electromagnetic energy to objects according to some embodiments of the present invention;

FIG. 8 is a diagrammatic illustration of a positioning element according to some embodiments of the present invention;

FIGS. 9 and 10 are tables showing exemplary scripts that may be recorded during heating of a benchmark object with a feedback-based heating apparatus; and

FIG. 11 is a flowchart of a method of heating a target object in a feedback-free heating apparatus according to some embodiments of the invention.

### DETAILED DESCRIPTION

An aspect of some embodiments of the disclosed technology includes applying electromagnetic (EM) energy, for example, RF energy, to an object, such as a target object. The energy may be applied to the target object when the target object, or a portion thereof, is inside an energy application zone, such as a resonant cavity of a microwave oven (e.g., cooking oven) or other heating apparatus. The EM energy may be applied via one or more radiating elements.

In some embodiments, the amounts of EM energy supplied to the radiating elements may be adjusted during heating such that the adjustments follow changes in a control parameter.

The control parameter may measure (or otherwise be indicative of) interaction between the object in the energy application zone and the electromagnetic energy. For example, the control parameter may measure a portion of supplied energy that is absorbed by the object.

In some embodiments, the supplied energy may follow or track changes in the control parameter. For example, the control parameter may be a value indicative of energy absorbable by the object, and the energy application (e.g., the heating process) may follow changes in this value. For example, less energy may be supplied at frequencies that are better absorbed.

In some embodiments, changes in the control parameter may be followed in the absence of feedback regarding the value of the control parameter. Feedback may be considered regarding a control parameter if the control parameter is derivable from the feedback. For example, if the control parameter is the ratio between incident power and reflected power, and the incident power is known independently of the feedback, feedback from which the reflected power may be derived online may be considered feedback regarding the control parameter. In the above example, changes in the value indicative of energy absorbable by the object may be followed in absence of feedback regarding this value or any feedback allowing computation of this value.

In some embodiments, changes in the control parameter are followed based on data collected before the energy application began, for example, before the object was placed in the energy application zone (i.e., without real-time feedback).

In some embodiments, the data is gathered during heating of a benchmark object, which can be similar at least in energy absorption characteristics to the target object, to be heated in absence of feedback. The benchmark object may be heated in presence of feedback, and data regarding the obtained feedback (e.g., data obtained by processing the feedback) may be recorded, and used for heating the target object. This may result in an energy application process (e.g., heating process) that follows changes in the control parameter without direct feedback (e.g., measurement) regarding these changes.

In the above example, the data gathered may include values indicative of energy absorbable by a benchmark object heated by an oven capable of obtaining real-time or other feedback regarding energy absorption (a “feedback-based” oven). The feedback-free oven may use these data and/or similar data or a similar datum to follow changes that happened during heating of the benchmark object. It is to be understood that the term “data,” as used herein, is inclusive of both an array of data values as well as a single datum (e.g., a single value of a particular quantity relevant to feedback). If the control parameter changes during heating of the target object the same way it changed during heating the benchmark object, the feedback-free oven also follows changes that happen during the heating of the target object, in absence of feedback regarding these changes. In some embodiments, the feedback-free oven may operate without any feedback whatsoever from the energy application zone, and still follow changes that occur in the control parameter.

The target object and the benchmark object may be similar at least in their response to the applied energy, for example. They may be, for example, two exemplars of the same type or object, like two loafs of bread made of the same dough and having the same weight and shape.

An oven that lacks the capability to obtain real-time feedback regarding the control parameter, for example, energy absorption, will be referred to herein as a “feedback-free oven.” It is to be understood that a “feedback-free oven” lacks feedback regarding the control parameter, but may receive feedback from the energy application zone or from elsewhere regarding conditions and parameters, from which the control parameter is not derivable. For example, in some embodiments, a feedback-free oven may receive feedback from which the temperature and/or humidity in the energy application zone are derivable, so long as the temperature and/or humidity are not the control parameters. On the other hand, a “feedback-based oven” is an oven including, for example, sensors and/or detectors for measuring conditions and parameters during use, and uses the conditions and parameters as control parameters for running the oven. A “benchmark oven” may be a “feedback-based oven” that may be used for generating data used to run a feedback-free oven. Feedback-based ovens, including benchmark ovens, may be similar, or even identical to feedback-free ovens, except for the existence (in the benchmark/feedback-based ovens) or absence (in the feedback-free ovens) of feedback collectors, processors sensors, and/or detectors. For example: the feedback-based and feedback-free ovens may have a similar cavity design (e.g., include cavities of similar dimensions, cavity walls made of similar materials, one or more radiating elements located at similar locations).

Objects to be heated in ovens may have “exemplars.” When used herein, an object's “exemplar” refers to an example or sample of the object that may be used for the purposes of obtaining data relating to control parameters (e.g., to oven control parameters) and/or relating to parameters indicative of energy absorbable by the object.

In some embodiments, the feedback-free oven may receive, via interface, data gathered before energy application began. The interface may include, for example, a reader of a machine readable element, a keypad, a touch-screen, and/or any other data entry mechanism or other interface between a machine and data source. The data source may be external to the machine. For example, the data source may be a barcode, carrying the data. In some examples, the data source may be a storage, for example, on server accessible through the Internet. Data gathered before energy application began, and/or data gathered on a different apparatus (or information based on such data) may be entered via the interface, for example, read from the data source (e.g., from a machine readable element associated with the target object), and used to control the heating of the target object.

In some embodiments, data gathered during heating of benchmark objects of various kinds, (dough, meat, or vegetables, for example) may be saved on a memory. The memory may be accessible to the feedback-free oven. For example, the memory be in the feedback-free oven. The interface may receive information indicative of a kind of the target object. Such or similar information may be used for among other things, locating in the memory the information related to objects of the same kind. This information may be used for controlling the heating of the target object.

In some embodiments, following changes in a control parameter may include supplying energy when the control parameter is below (or above) a given threshold.

In some embodiments, following changes in a control parameter may include supplying energy to a radiating element in amounts that increase (or decrease) when the control parameter decreases. For example, the amount of energy supplied at one frequency to a radiating element may increase when the control parameter decreases at that frequency, e.g., when the amount of energy absorbable by the object at that frequency decreases.

Thus, in some exemplary embodiments, there may be provided an apparatus for applying electromagnetic energy to an object in a first energy application zone, e.g., an energy application zone of a feedback-free oven, based on data collected during energy application in a second energy application zone, e.g., an energy application zone of a feedback-based oven. The data may have been collected in the second energy application zone in presence of feedback from the second energy application zone regarding the MSE-dependent parameter.

The apparatus may include at least one processor configured to cause one or more radiating elements to apply RF energy to the first energy application zone. In some embodiments, the apparatus may further include the one or more radiating elements and/or the first energy application zone. The energy application caused by the at least one processor may be at two or more frequencies, phases, and/or at a plurality of MSEs of other kinds. The term MSE is discussed in length below.

In some embodiments, the data, based on which energy application may be adjusted, is indicative of weights to be associated with different MSEs in a heating process by the feedback-free oven. For example, the data may be indicative of how much energy is to be supplied to a radiating element at each frequency. In another example, the data may be indicative of power levels, at which energy is to be applied at each MSE, for example, at each frequency and/or phase. Additionally or alternatively, the data may be indicative of time periods, at which energy is to be applied at each MSE. In some embodiments, the data may be indicative of the weights applied during processing in the feedback-based oven. In some embodiments, the weights applied during processing in the feedback-based oven and the weights applied during processing in the feedback-free oven may be the same.

The at least one processor may be further configured to adjust the energy supplied to the radiating elements such that the supplied energy follows changes in an MSE-dependent parameter. In some embodiments, the processor may be configured to adjust the energy supplied to the radiating elements such that the supplied energy follows changes in an MSE-dependent parameter. In some embodiments, a change over a range of MSEs may be followed. For example, the supplied energy may change from one MSE to another corresponding to the change of the MSE-dependent parameter from the one MSE to the other. In some embodiments, such energy supply may be caused in absence of feedback on the way the control parameter actually changes in the feedback-free oven. In some embodiments, the adjustment may be based on data having been collected during energy application in the second energy application zone, for example, before the object is placed in the first energy application zone, rather than by measurements taken in the first energy application zone. Adjustment of supplied energy may include, in some embodiments, adjustments of amounts of energy applied at each MSE. The amounts of energy may be adjusted by selection amounts from a group of three or more energy amount values, for example, 0, ½, and 1.

It is noted that in some embodiments, energy supply is adjusted by the at least one processor more than once during energy application, for example, every minute, several times a minute, etc. The rate of energy supply or energy application adjustments may depend on the data on which the adjustments are based. In some embodiments, the data may be sufficiently detailed to allow adjustments every 1 minute, every two minutes, once in 10 minutes, once in 10 seconds, etc. The amount of data may be dictated by the memory available for storage of the data, and by the rate at which energy supply adjustments are required to substantially reproduce the heating process that occurred in the feedback-based oven.

In some embodiments, the data may be received in the first, feedback-free, apparatus through an interface. The interface may be configured to receive data from a data source external to the apparatus. For example, the interface may include a reader of a machine readable element, a keypad, a touch-screen, cable for cable communication, and/or wireless communication devices.

An apparatus as described above, may implement a method of applying electromagnetic energy, which is provided by the present disclosure independently of the structure of the apparatus. Thus, in one method provided by the present disclosure, energy may be applied at two or more MSEs to an object placed in a first energy application zone, e.g., of a feedback-free oven, through one or more radiating elements. The method may include receiving data collected during processing of an object in a second energy application zone, e.g., in an energy application zone of a feedback-based oven; and adjusting energy supplied to the at least one radiating element based on the data, such that an amount of the supplied energy follows changes in an MSE-dependent control parameter.

A feedback-based oven (or other feedback-based energy application apparatus) may implement a method comprising heating an object in a first apparatus, which may be the feedback-based oven itself, recording information regarding the heating process, and allowing a second apparatus, e.g., a feedback-free oven, to access the information. The heating in the first apparatus may be according to feedback regarding an MSE dependent control parameter, and the recorded information may be sufficient to substantially reproduce the heating (or other processing) process in absence of feedback regarding the MSE dependent control parameter, e.g., by a feedback-free oven.

There may be many ways in which access to the information may be allowed to a second apparatus (e.g., to a feedback-free oven), and the method is not limited to any particular such method. For example, in some embodiments, access to the information is allowed by recording the information to a machine readable element, such that a feedback-free oven equipped with a suitable reader of machine readable elements may read the information from the machine readable element. For example, the information may be recorded onto a barcode, such that a feedback-free oven with a suitable barcode reader may gain access to the information. In some embodiments, the information may be encoded on the machine readable element, and the second apparatus may include a processor configured to decode the code so as to obtain the information.

In some embodiments, access to the information is allowed by storing the information on a storage device that the second apparatus may access. For example, the information may be stored on memory in the second apparatus. In another example, the information may be stored on an Internet server or other storage device, and the second apparatus may be provided with data that allows access to the information on the storage device, for example, a barcode or other machine readable element may include a code for a specific address on the storage device on which the information is stored or may include an identification number (e.g., tag ID) which may address the processor to specific information on the storage device (e.g., to a look up table that associates ID numbers to heating protocols). This way, an apparatus that can read the machine readable element and decode the code may be able to gain access to the information.

The present disclosure also provides a product that may be processed in a feedback-free oven based on information gathered when an object, possibly an exemplar of the product, was processed in a feedback-based oven. An example of such a product may be a packaged product, which includes a first food item packed for consumer use; and a machine readable element associated with the first food item. The machine readable element may allow access to data collected when a second food item, possibly an exemplar of the first food item, was processed by electromagnetic energy at multiple MSEs. The processing may include, for example, thawing, heating, drying and/or cooking. In some embodiments, the machine readable element allows access to the data to a first apparatus, and the data has been collected when the second food item was processed in a second apparatus. In some embodiments, the data may have been collected when the second food item was cooked at multiple MSEs in presence of feedback regarding the control parameter.

It is noted that the terms “first” and “second” are used here freely, and in some places a “first apparatus” may refer to a feedback-free apparatus, while in some places, a “first apparatus” may refer to a feedback-based apparatus, all in accordance with the context at which these terms are used.

Finally, some embodiments may include a system comprising an apparatus for applying RF energy to an object, and an object. The apparatus and/or the object may be as describe above. In some such systems, the object may be associated with a code; and the apparatus may include an interface for receiving the code and a processor configured to decode the code to operation instructions of the apparatus. The operation instructions may be such that when carried out, changes that occur in a control parameter during the operation are followed in absence of feedback regarding the changes.

Reference will now be made in detail to exemplary embodiments of the invention, examples of which are illustrated in the accompanying drawings. When convenient, the same reference numbers are used throughout the drawings to refer to the same or like parts.

At least some of the disclosed embodiments may involve apparatus and methods for applying electromagnetic energy. The term electromagnetic energy, as used herein, includes any or all portions of the electromagnetic spectrum, including but not limited to, radio frequency (RF), infrared (IR), near infrared, visible light, ultraviolet, etc. Applying energy in the RF portion of the electromagnetic spectrum is referred herein as “applying RF energy.” In one particular example, applied electromagnetic energy may include RF energy with a wavelength in free space of 100 km to 1 mm, which corresponds to a frequency of 3 KHz to 300 GHz, respectively. In some other examples, the applied electromagnetic energy may fall within frequency bands between 500 MHz to 1500 MHz or between 700 MHz to 1200 MHz or between 800 MHz-1 GHz. In some other examples, the applied electromagnetic energy may fall within one or more industrial, scientific, and medical (ISM) frequency bands, for example, between 433.05 and 434.79 MHz, between 902 and 928 MHz, between 2400 and 2500 MHz, and/or between 5725 and 5875 MHz. Microwave and ultra high frequency (UHF) energy, for example, are both within the RF range. Even though examples of the invention are described herein in connection with the application of RF energy, these descriptions are provided to illustrate a few exemplary principles of the invention, and are not intended to limit the invention to any particular portion of the electromagnetic spectrum.

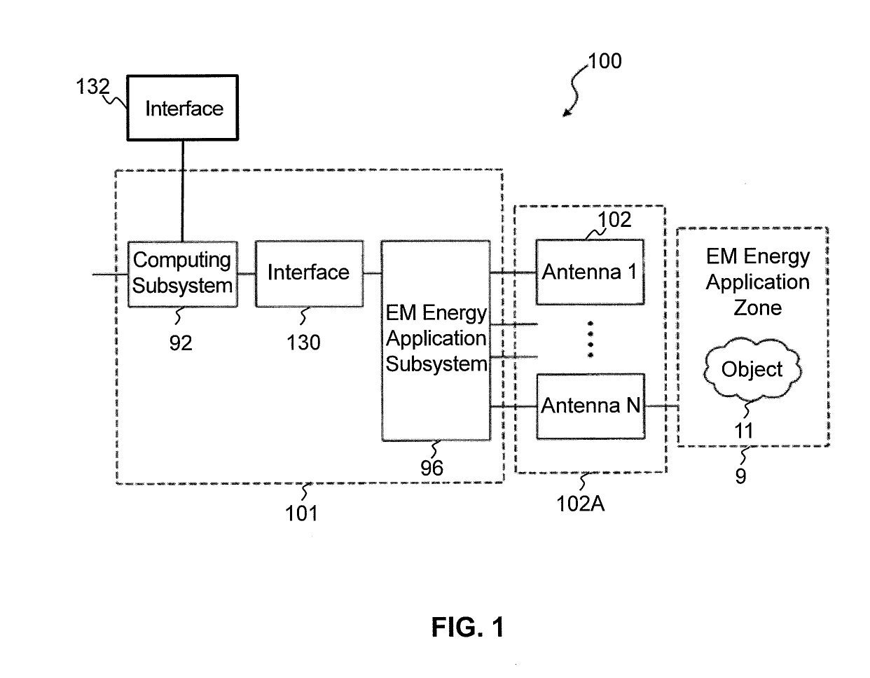

In certain embodiments, the application of electromagnetic energy may occur in an energy application zone, such as energy application zone 9, as shown in FIG. 1. Energy application zone 9 may include any void, location, region, or area where electromagnetic energy may be applied. It may be hollow, or may be filled or partially filled with liquids, solids, gases, or combinations thereof. By way of example only, energy application zone 9 may include an interior of an enclosure, interior of a partial enclosure, open space, solid, or partial solid, that allows existence, propagation, and/or resonance of electromagnetic waves. Zone 9 may include a conveyor belt or a rotating plate. For purposes of this disclosure, all such energy application zones may alternatively be referred to as cavities. It is to be understood that an object is considered “in” the energy application zone if at least a portion of the object is located in the zone or if some portion of the object receives delivered electromagnetic radiation.

Exemplary energy application zone 9 may include locations where energy is applied in an oven (e.g., cooking oven), chamber, tank, dryer, thawer, dehydrator, reactor, engine, filter, chemical or biological processing apparatus, furnace, incinerator, material shaping or forming apparatus, conveyor, combustion zone, cooler, freezer, etc. All these may, in certain embodiments, constitute an oven. In some embodiments, the energy application zone may be part of a vending machine, in which objects are processed once purchased.

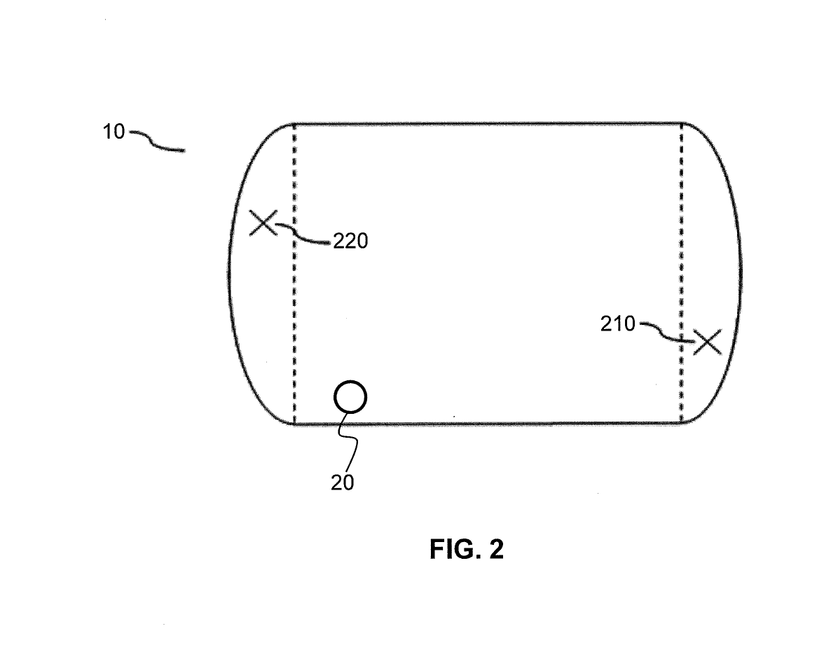

Consistent with the presently disclosed embodiments, energy application zone 9 may include an electromagnetic resonator 10 (also known as cavity resonator, or cavity) (illustrated for example in FIG. 2). At times, energy application zone 9 may be congruent with the object or a portion of the object (e.g., the object or a portion thereof, is or may define the energy application zone).

In accordance with some embodiments of the invention, an apparatus or method may involve the use of at least one source configured to deliver electromagnetic energy to the energy application zone (e.g., by supplying electromagnetic energy to radiating element(s) provided in the zone). A source of electromagnetic energy (or source), may include any component(s) that are suitable for generating and delivering electromagnetic energy.

Consistent with some embodiments of the invention, electromagnetic energy may be delivered (applied) to the energy application zone in the form of propagating electromagnetic waves at predetermined wavelengths or frequencies (also known as electromagnetic radiation). As used consistently herein, “propagating electromagnetic waves” may include resonating waves, evanescent waves, and waves that travel through a medium in any other manner.

As used herein, if a machine (e.g., a processor or a source) is described as “configured to” perform a task (e.g., configured to deliver electromagnetic energy to the energy application zone), the machine includes any parts, software or hardware, necessary for performing the task. In some embodiments, the machine performs this task during operation. Similarly, when a task is described as being done “in order to” establish a target result (e.g., regulate an amplitude modulator in order to alter an amplitude), then, at least in some embodiments, carrying out the task would accomplish the target result.

Electromagnetic radiation carries energy that may be imparted to (or dissipated into) matter with which it interacts. In certain embodiments, electromagnetic energy may be applied to an object 11. References to an “object” (or “object to be heated” or “object to be processed”), to which electromagnetic energy is applied, is not limited to a particular form. An object may include a liquid, semi-liquid, solid, semi-solid, or gas, depending upon a particular application. An object may also include composites or mixtures of matter in differing phases. Thus, by way of non-limiting example, the term “object” encompasses such matter as food to be defrosted or cooked; clothes or other wet material to be dried; frozen organs to be thawed; chemicals to be reacted; fuel or other combustible material to be combusted; hydrated material to be dehydrated, frozen blood products to be thawed, cooled blood products to be heated, gases to be expanded; liquids to be heated, boiled or vaporized, or any other material for which there is a desire to apply, even nominally, electromagnetic energy.

In some embodiments, object 11 may constitute at least a portion of a load. For example, a portion of electromagnetic energy applied or delivered to energy application zone 9 may be absorbed by object 11. In some embodiments, another portion of the electromagnetic energy applied or delivered to energy application zone 9 may be absorbed by various elements (e.g., food residue, particle residue, additional objects, structures associated with zone 9, or any other electromagnetic energy-absorbing materials found in zone 9) associated with energy application zone 9. Energy application zone 9 may also include loss constituents that do not, themselves, absorb an appreciable amount of electromagnetic energy, but otherwise account for electromagnetic energy losses. Such loss constituents may include, for example, cracks, seams, joints, doors, cavity-door interface, or any other loss mechanisms associated with energy application zone 9. Thus, in some embodiments, a load may include at least a portion of object 11 along with any electromagnetic energy-absorbing constituents in the energy application zone as well as any electromagnetic energy loss constituents associated with the zone.

FIG. 1 is a diagrammatic representation of an apparatus 100 for applying electromagnetic energy to an object, in accordance with some embodiments of the invention. Apparatus 100 may include a controller 101, one or more antennas 102, which may be arranged in an antenna array 102A, and energy application zone 9. Controller 101 may be electrically coupled to one or more antennas 102 either through a direct or indirect electrical connection. Controller 101 may include a computing subsystem 92, an interface 130, and an electromagnetic energy application subsystem 96. Based on an output of computing subsystem 92, energy application subsystem 96 may respond by generating one or more radio frequency signals to be supplied to antennas 102. In turn, the one or more antennas 102 may radiate electromagnetic energy into energy application zone 9. In certain embodiments, this energy can interact with object 11 positioned within energy application zone 9.

Consistent with the presently disclosed embodiments, computing subsystem 92 may include a general purpose or special purpose computer. Computing subsystem 92 may be configured to generate control signals for controlling electromagnetic energy application subsystem 96 via interface 130. Computing subsystem 92 may receive data, information, and/or instructions regarding the desired processing from sources outside apparatus 100, for example, through interface 132. Interface 132 may include, for example, a keypad, a barcode reader, and/or a touch-screen and/or a wireless or other data connection/link. In a feedback-based apparatus, computing subsystem 92 may further receive measured signals from electromagnetic energy application subsystem 96 via interface 130. EM energy application subsystem 96 may include a dual directional coupler (not shown) connected to each of antennas 102. Feedback-free apparatus may omit the dual directional coupler.

While controller 101 is illustrated for exemplary purposes as having three subcomponents, control functions may be consolidated in fewer components, or additional components may be included consistent with the desired function and/or design of a particular embodiment.

FIG. 2 shows a top view of a cavity 10, which is one exemplary embodiment of energy application zone 9. Cavity 10 may be cylindrical in shape (or any other suitable shape, such as semi-cylindrical, rectangular, elliptical, cuboid, symmetrical, asymmetrical, irregular, and regular, among others) and may be made of a conductor, such as aluminum, stainless steel or any suitable metal or other conductive material. In some embodiments, cavity 10 may include walls coated and/or covered with a protective coating, for example, made from materials transparent to EM energy, e.g., metallic oxides or others. In some embodiments, cavity 10 may have a spherical shape or hemispherical shape. Cavity 10 may be resonant in frequencies within a predetermined range of frequencies (e.g., within the UHF or microwave range of frequencies, such as between 300 MHz and 3 GHz, between 400 MHz and 1 GHZ, or between 800 MHZ and 1 GHZ). It is also contemplated that cavity 10 may be closed, e.g., completely enclosed (e.g., by conductor materials), bounded at least partially, or open, e.g., having non-bounded openings. The general methodology of the invention is not limited to any particular cavity shape or configuration, as discussed earlier. Cavity 10 may include a sensor 20 (which may be, for example, omitted in a feedback-free apparatus) and antennas 210 and 220(examples of antennas 102 shown in FIG. 1).

In some embodiments, e.g., of a feedback-based apparatus, one or more sensor(s) or detector(s), e.g., sensor 20, may be used to sense (or detect) information (e.g., feedback signals) relating to object 11 and/or to the energy application process and/or the energy application zone. At times, one or more radiating elements, e.g., antenna 102, may be used as sensors. The sensors may be used to supply feedback or to sense any information, including temperature, weight, humidity, volume, PH, pressure, motion. The sensed information may be sent to computing subsystem 92 (e.g., through interface 130) for further use (e.g., may be used to adjust heating parameters). The sensed information may be used for any purpose, for example: display to a user operating the apparatus, process verification, automation, authentication, safety, etc.

In some embodiments, field adjusting element(s) (not illustrated) may be provided in energy application zone 9, for example, in cavity 10. Field adjusting element(s) may be adjusted to change the electromagnetic wave pattern in the cavity in a way that selectively directs the electromagnetic energy from one or more of antennas 102 into object 11.

In the presently disclosed embodiments, more than one feed and/or a plurality of radiating elements (e.g., antennas) may be provided. A feed may include, for example, a radiating element, and a waveguide connecting the radiating element to an RF generator or other energy source. The radiating elements may be located on one or more surfaces of, e.g., an enclosure defining the energy application zone. Alternatively, radiating elements may be located inside or outside the energy application zone. One or more of the radiating elements may be near to, in contact with, in the vicinity of or even embedded in object 11 (e.g., when the object is a liquid). The orientation and/or configuration of each radiating element may be distinct or the same, based on the specific energy application, e.g., based on a desired target effect. Each radiating element may be positioned, adjusted, and/or oriented to radiate electromagnetic waves along a same direction, or various different directions. Furthermore, the location, orientation, and configuration of each radiating element may be predetermined before applying energy to the object. Alternatively or additionally, the location, orientation, and configuration of each radiating element may be dynamically adjusted, for example, by using a processor (controller), during operation of the apparatus and/or between rounds of energy application. The invention is not limited to radiating elements having particular structures or locations within the apparatus.

As represented by the block diagram of FIG. 1, apparatus 100 may include at least one radiating element in the form of at least one antenna 102 for delivery (application) of electromagnetic energy to energy application zone 9.

As used herein, the terms “radiating element” and “antenna” may broadly refer to any structure from which electromagnetic energy may radiate, regardless of whether the structure was originally designed for the purposes of radiating energy, and regardless of whether the structure serves any additional function. For example, a radiating element or an antenna may include an aperture/slot antenna, or an antenna which includes a plurality of terminals radiating in unison, either at the same time or at a controlled dynamic phase difference (e.g., a phased array antenna). Consistent with some exemplary embodiments, radiating elements (e.g., antennas 102) may be configured to deliver (feed) electromagnetic energy into electromagnetic energy application zone 9. Such radiating elements may be referred to herein as “transmitting antennas” or “emitters”. A transmitting antenna may also be a receiver (also referred to herein as “a receiving antenna”), e.g., may receive electromagnetic energy from energy application zone 9. So, for example, a single antenna may be configured to both apply electromagnetic energy to zone 9 and to receive electromagnetic energy from zone 9. At times, in addition to or as an alternative to delivering (applying) energy, an antenna may also be adjusted to affect the field pattern. For example, various properties of the antenna, such as position, location, orientation, etc., may be adjusted. Different antenna property settings may result in differing electromagnetic field patterns within the energy application zone thereby affecting energy absorption in the object. Therefore, antenna adjustments may constitute one or more variables that can be varied in controlling energy application to the energy application zone.

Consistent with the presently disclosed embodiments, energy may be supplied and/or provided to one or more transmitting antennas. Energy supplied to a transmitting antenna may result in energy emitted by the transmitting antenna (referred to herein as “incident energy”). The incident energy may be delivered to zone 9, and may be in an amount equal to an amount of energy supplied to the transmitting antenna(s) by a source. A portion of the incident energy may be dissipated in the object or absorbed by the object (referred to herein as “dissipated energy” or “absorbed energy”). Another portion may be reflected back to the transmitting antenna (referred to herein as “reflected energy”). Reflected energy may include, for example, energy reflected back to the transmitting antenna due to mismatch caused by the object and/or the energy application zone, e.g., impedance mismatch. Reflected energy may also include energy retained by the port of the transmitting antenna (e.g., energy that is emitted by the antenna but does not flow into the zone). The rest of the incident energy, other than the reflected energy and dissipated energy, may be coupled to one or more antennas other than the transmitting antenna (referred to herein as “coupled energy”). Therefore, the incident energy (“I”) supplied to the transmitting antenna may include all of the dissipated energy (“D”), reflected energy (“R”), and coupled energy (“T”), and may be expressed according to the relationship presented in equation (1):

I=D+R+ΣTᵢ. (1)

In accordance with certain aspects of the invention, the one or more transmitting antennas may deliver electromagnetic energy into zone 9. Energy delivered by a transmitting antenna into the zone (referred to herein as “delivered energy” or (d)) may be the incident energy emitted by the antenna minus the reflected energy at the same antenna. That is, the delivered energy may be the net energy that flows from the transmitting antenna to the zone, i.e., d=I−R. Alternatively, the delivered energy may also be represented as the sum of reflected energy and transmitted energy, i.e., d=D+T (where T=ΣTᵢ).

Dissipated, reflected, and coupled energies may exist both in a feedback-based and in a feedback-free apparatus, however, a feedback-based apparatus may have detectors for measuring the size of I, D, R, and/or T, while feedback-free apparatus may function without measuring any of these, and still follow them as they change. In some embodiments, detectors may be the radiating elements, e.g., antennas 102, when function as receivers. The omission of detection and measurement may obviate the need to employ expensive measurement equipment.

In certain embodiments, the application of electromagnetic energy may occur via one or more feeds. A feed may include one or more waveguides and/or one or more radiating elements (e.g., antennas 102) for applying electromagnetic energy to the zone. Such antennas may include, for example, patch antennas, fractal antennas, helix antennas, log-periodic antennas, spiral antennas, slot antennas, dipole antennas, loop antennas, slow wave antennas, leaky wave antennas or any other structures capable of transmitting (emitting) and/or receiving electromagnetic energy.

The invention is not limited to antennas having particular structures or locations. Antennas, e.g., antenna 102, may be polarized in differing directions in order to, for example, reduce coupling, enhance specific field pattern(s), increase the energy delivery efficiency, and support and/or enable a specific algorithm(s). The foregoing are examples only, and polarization may be used for other purposes as well. In one example, three antennas may be placed parallel to orthogonal coordinates, however, it is contemplated that any suitable number of antennas (such as one, two, three, four, five, six, seven, eight, etc.) may be used. For example, a higher number of antennas may add flexibility in system design and improve control of energy distribution, e.g., greater uniformity and/or resolution of energy application in zone 9.

In some embodiments, one or more of antennas 102 may be slow wave antenna(s). A slow-wave antenna may refer to a wave-guiding structure that possesses a mechanism that permits it to emit power along all or part of its length. The slow wave antenna may comprise a plurality of slots to enable EM energy to be emitted. In some embodiments, the object to be processed, e.g., cooked, may be placed in the energy application zone so that a coupling may be formed between an evanescent EM wave (e.g., emitted from a slow wave antenna) and the object. An evanescent EM wave in free space (e.g., in the vicinity of the slow wave antenna) may be non-evanescent in the object. A coupling between a load (e.g., object) and the evanescent wave emitted from the slow wave antenna such that the wave is resonant in the load, may be referred as “load resonance”. In some exemplary embodiments, the processor (e.g., controller 101 or processor 2030, 2030B) may be configured to choose at least one frequency (which may be referred as load resonance frequencies) in which the EM energy may be applied to the energy application zone such that a load resonance coupling may be performed

Radiating elements, e.g., antenna 102, may be configured to feed energy at specifically chosen modulation space elements, referred to herein as MSEs, which may be chosen by controller 101. The term “modulation space” or “MS” is used to collectively refer to all the parameters that may affect a field pattern in the energy application zone and all combinations thereof. In some embodiments, the “MS” may include all possible components that may be used and their potential settings (absolute and/or relative to others) and adjustable parameters associated with the components. For example, the “MS” may include the number of antennas, their positioning and/or orientation (if modifiable), the useable bandwidth, a set of all useable frequencies and any combinations thereof, power settings, phases, boundary conditions modifiers (described below), etc. The MS may have any number of possible variable parameters, ranging between one parameter only (e.g., a one dimensional MS limited to frequency only or phase only—or other single parameter), two or more dimensions (e.g., varying frequency and amplitude or varying frequency and phase together within the same MS), or many more.

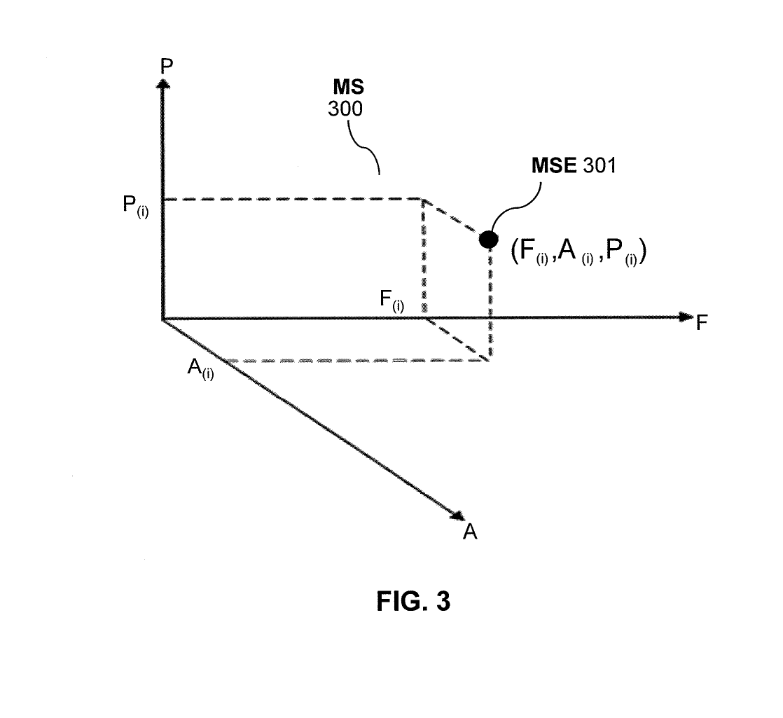

Each variable parameter associated with the MS is referred to as an MS dimension. By way of example, FIG. 3 illustrates a three dimensional modulation space 300, with three dimensions designated as frequency (F), phase (P), and amplitude (A). That is, in MS 300, frequency, phase, and amplitude (e.g., an amplitude difference between two or more waves being radiated at the same time) of the electromagnetic waves are modulated during energy application, while all the other parameters may be fixed during energy application. In FIG. 3, the modulation space is depicted in three dimensions for ease of discussion only. The MS may have any number of dimensions, e.g., one dimension, two dimensions, four dimensions, n dimensions, etc. In one example, a one dimensional modulation space oven may provide MSEs that differ one from the other only by frequency.

The term “modulation space element” or “MSE,” may refer to a specific set of values of the variable parameters in MS. Therefore, the MS may also be considered to be a collection of all possible MSEs. For example, two MSEs may differ one from another in the relative amplitudes of the energy being supplied to a plurality of radiating elements. For example, FIG. 3 shows an MSE 301 in the three-dimensional MS 300. MSE 301 has a specific frequency F(i), a specific phase P(i), and a specific amplitude A(i). If even one of these MSE variables changes, then the new set defines another MSE. For example, (3 GHz, 30°, 12 V) and (3 GHz, 60°, 12 V) are two different MSEs, although only the phase component is different.

MSEs are not limited to sets of values of frequency, phase, and amplitude, but may also or alternatively include values of any parameter that affects field patterns developed (generated) in the energy application zone. One such parameter is a state or states of boundary condition modifiers. A boundary condition modifier may be any element adjustable to alter a field pattern excited in the energy application zone by altering, for example, the boundary conditions imposed on the electromagnetic field in the energy application zone.

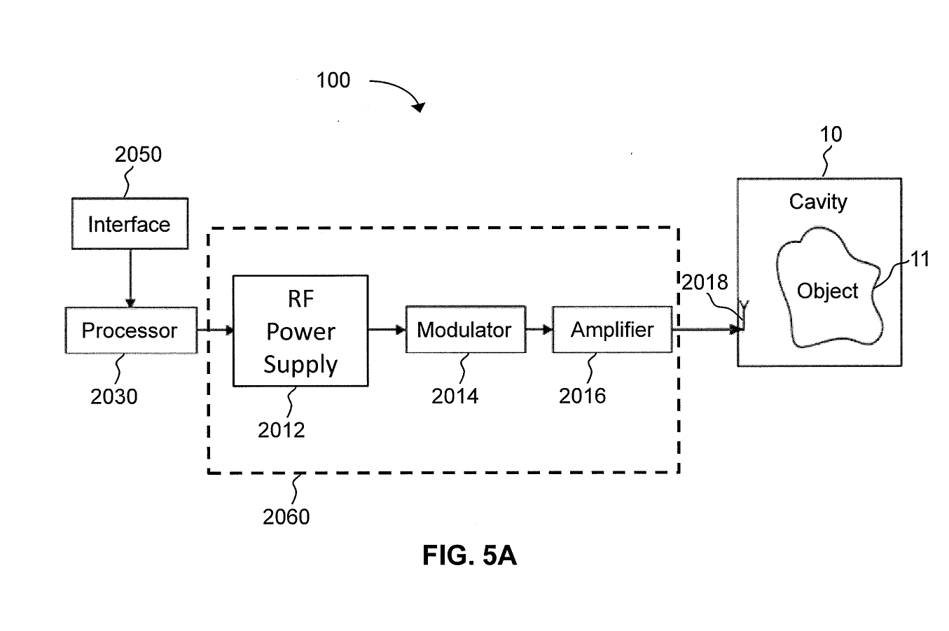

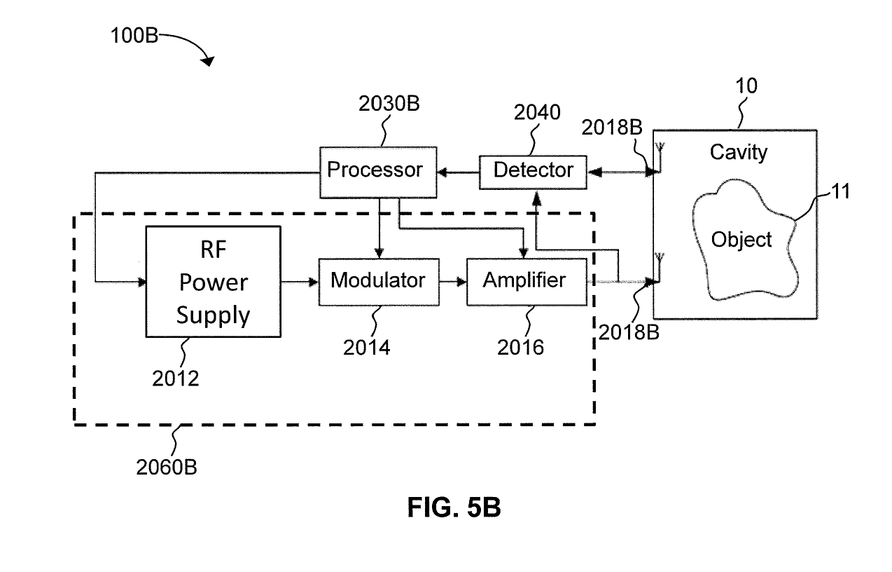

One exemplary boundary condition modifier may be a conductive element that can switch from a “floating” state (e.g., electrically insulated from the cavity walls) to a “connected” state (e.g., electrically connected to the cavity walls) and vice versa. It has been found by the applicants that the state of such an element may alter the field pattern developed in the energy application zone. Thus, in some embodiments, controller 101 or processor 2030/2030B (in FIG. 5A/5B) may control the state of the conductive element or elements, and this way alter the field pattern developed in the energy application zone. The state of the element (e.g., connected or floating) may be an element of a modulation space.

Another exemplary boundary condition modifier may, for example, include a ferrite element in the vicinity of an electromagnet. The ferrite element may impose boundary conditions on the electromagnetic field by, for example, creating a magnetic field in the energy application zone. An intensity of this magnetic field may depend on the current that flows in the electromagnet. By controlling the current, the boundary conditions, and with them the field patterns, may be controlled. In at least this way, the current intensity may be an element of a modulation space.

Another exemplary boundary condition modifier may include a conductive element having a controllable position or orientation, for example, a metallic shutter. Changing the position and/or orientation of the metallic element may change the boundary conditions imposed on the electric field in the energy application zone. Thus, the position and/or orientation may be element(s) of a modulation space.

Some embodiments may include one or more boundary condition modifiers, and a controller and/or processor configured to control (adjust) them.

Differing combinations of MS parameters may lead to differing field patterns across the energy application zone and differing energy distribution patterns in the object. A plurality of MSEs that can be executed sequentially or simultaneously to excite a particular field pattern in the energy application zone may be collectively referred to as an “energy delivery scheme”. For example, an energy delivery scheme may consist of three MSEs: (F(1), P(1), A(1)); (F(2), P(2), A(2)) (F(3), P(3), A(3)). Such an energy delivery scheme may result in applying the first, second, and third MSE to the energy application zone. An energy delivery scheme may also be referred to as a heating protocol, and may also include parameters such as durations, for which each of the MSEs is to be applied, power levels to be applied at each of the MSEs, the order at which the MSEs are to be applied, etc.

The invention, in its broadest sense, is not limited to any particular number of MSEs or MSE combinations. Various MSE combinations may be used depending on the requirements of a particular application and/or on a desired energy delivery profile, and/or given equipment, e.g., cavity dimensions. The number of options that may be employed could be as few as two or as many as the designer desires, depending on factors such as intended use, level of desired control, hardware or software resolution and cost.

In certain embodiments, there may be provided at least one processor. As used herein, the term “processor” may include an electric circuit that performs a logic operation on input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations. The at least one processor may be coincident with or may be part of controller 101.

The instructions executed by the processor may, for example, be pre-loaded into the processor or may be stored in a separate memory unit such as a RAM, a ROM, a hard disk, an optical disk, a magnetic medium, a flash memory, other permanent, fixed, or volatile memory, or any other mechanism capable of storing instructions for the processor. The processor(s) may be customized for a particular use, or can be configured for general-purpose use and can perform different functions by executing different software.

If more than one processor is employed, all may be of similar construction, or they may be of differing constructions electrically connected or disconnected from each other. They may be separate circuits or integrated in a single circuit. When more than one processor is used, they may be configured to operate independently or collaboratively. They may be coupled electrically, magnetically, optically, acoustically, mechanically or by other means permitting them to interact.

The at least one processor may be configured to cause electromagnetic energy to be applied to zone 9 via one or more antennas, for example across a series of MSEs, in order to apply electromagnetic energy at each such MSE to object 11. For example, the at least one processor may be configured to regulate one or more components of controller 101 in order to cause the energy to be applied.

In some embodiments, energy application may be conducted through a sweep. As used herein, a sweep may include, for example, the transmission over time of energy at more than one MSE. For example, a sweep may include the sequential transmission of energy at multiple MSEs in one or more contiguous MSE band (e.g., a frequency band); the sequential transmission of energy at multiple MSEs in more than one non-contiguous MSE band; the sequential transmission of energy at individual non-contiguous MSEs; and/or the transmission of synthesized pulses having a desired MSE/power spectral content (e.g., a synthesized pulse in time). The MSE bands may be contiguous or non-contiguous. Thus, during an MSE sweeping process, the at least one processor may regulate the energy supplied to the at least one radiating element to sequentially apply electromagnetic energy at various MSEs to zone 9.

In certain embodiments, the at least one processor may be configured to determine a value indicative of energy absorbable by the object at each of a plurality of MSEs. This may occur, for example, in a feedback-free apparatus, using one or more lookup tables, and/or by pre-programming the processor or memory associated with the processor. For example, the at least one processor may receive the value indicative of energy absorbable by the object from a machine readable element. In another example, the at least one processor may receive from an interface an ID of the object, and find the appropriate values in a lookup table associated with the ID. The lookup table may be preprogrammed and/or received via an interface, for example, from the Internet or from a memory card.

In some embodiments, two or more heating protocols may be saved or stored on controller 101, processor 2030 or on a memory accessible to the processor and/or to the controller. The apparatus may include an interface (e.g., interface 132 or interface 2050) for receiving indication of which heating protocol or protocols to be used. For example, the apparatus may be a vending machine, and the interface may receive an indication of the product chosen by a user. Each product may be associated, for example, with one of the saved heating protocols or with a set of heating protocols to be applied sequentially at different sweeps.

A value indicative of energy absorbable by the object may include any suitable measure and/or estimate of the capacity of the object to further absorb EM energy.

Examples of values indicative of energy absorbable by the object may include network parameters (e.g., scattering parameters), their absolute values, ratios between incident energy and reflected energy, ratios between incident energy and coupled energy, and dissipation ratios.

A value indicative of energy absorbable by the object may be calculated based on measurements (direct and/or indirect), estimates, and/or simulations (e.g., computer-based and/or physical modeling-based) of a fraction or amount of incident energy that an object may absorb under certain conditions. A value indicative of energy absorbable by the object may also or alternatively be calculated based on measurements, simulations and/or estimates of amounts of energy supplied to the radiating element(s) and/or amounts of energy not dissipated in the object. The energy not dissipated in the object may include reflected EM radiation (e.g., amounts of energy reflected back to an emitting radiating element). The energy not dissipated in the object may also include energy coupled from an emitting radiating element to another radiating element and/or to a detector.

As used herein, a value indicative of energy absorbable by the object may be different from the object's temperature, volume, position, or orientation in the energy application zone, and so may be a control parameter in general. It is also to be understood, however, that a value indicative of energy absorbable by the object may depend upon or otherwise relate to combinations of the object's temperature, volume, position, or orientation in the energy application zone and that each of these parameters, as well as other parameters, may be used in a calculation or estimate of the value indicative of energy absorbable by the object.

The value indicative of energy absorbable by the object need not be obtained from a measurement of a property of the object. Rather, the value indicative of energy absorbable by the object may be obtained, for example, from measurements performed on exemplars of the object, on samples of the object, on samples of exemplars of the object or on any other object or material that would yield information indicative of the energy absorbable by the object.

Data “relating to” a value indicative of energy absorbable by the object may be any data that pertains to such a value. For example, data relating to a value indicative of energy absorbable by the object may include direct measures of the value indicative of energy absorbable by the object for the object itself or for exemplars of the object. Data relating to a value indicative of energy absorbable by the object may also be data resulting from measurements of properties of the object or other objects that have some relationship (mathematical or otherwise) to the value indicative of energy absorbable by the object. For example, data relating to a value indicative of energy absorbable by the object may include measurements of energy absorption, coupling and/or reflection by the object or exemplars of the object. Data relating to a value indicative of energy absorbable by the object may further include, for example, numerical or computational estimates of the value indicative of energy absorbable by the object obtained by, for example, computer simulation. Data relating to a value indicative of energy absorbable by the object may further include, for example, a combination of measured and computer-generated data and/or computationally analyzed data obtained either via measurement, computer simulation or a combination of the two.

A value indicative of energy absorbable by the object (also referred to herein as absorbable energy indicator) may be used as a control parameter, which the energy application may follow in the absence of feedback from the energy application zone regarding the energy absorbable by the object, and based on measurements made before the object was placed in the energy application zone. While the invention is not limited to any particular measure of energy absorbable in the object, or to any particular control parameter, various exemplary indicative values are discussed below.

Consistent with some of the presently disclosed embodiments, a value indicative of the absorbable energy (also referred to as absorbable energy value) may include a dissipation ratio (referred to herein as “DR”) associated with each of a plurality of MSEs. As referred to herein, a “dissipation ratio” (or “absorption efficiency” or “power efficiency”), may be defined as a ratio between electromagnetic energy absorbable by object 11 and electromagnetic energy supplied to radiating element(s) configured to apply energy to energy application zone 9. Thus, in some embodiments, the dissipation ratio may be a control parameter. One kind of dissipation ratio, referred to herein as DR, may be defined as in equation (2) below, wherein I stands for the energy (or power) supplied to a certain radiating element (the transmitting radiating element), R for the energy (or power) reflected back to the transmitting radiating element, and T for the energy (or power) coupled from the transmitting radiating element to all the other radiating elements (if any).

$$DR = \frac{I - ( R + T )}{I} . \qquad ( 2 )$$

Another kind of dissipation ratio, referred to herein as Δρ, may be defined as in equation (3) below

$$Δρ = \frac{d - T}{d} , \qquad ( 3 )$$

wherein d, the delivered energy, is given by d=I−R, as discussed above.

In both cases, the dissipation ratio or fraction may be a value between 0 and 1, and thus may be represented by a percentage or fraction. Also, in both cases, a different dissipation ratio may be associated with different radiating elements. In some embodiments, a product of the dissipation ratio DR by the incident energy or the product of Δρ by the delivered energy, may be an estimate of or may be considered equal to the amount of energy absorbed by the object.

Other functions of I, R, and T, for example, R, R/I, or T/d, may also be used as control parameters.

In certain embodiments, the at least one processor may be configured to cause energy to be supplied to the at least one radiating element in at least a subset of a plurality of MSEs. In some embodiments, the at least one processor may be configured to select the at least one subset of a plurality of MSEs based on the absorbable energy value measured at the corresponding MSEs. For example, in some embodiments, the at least one processor may be configured to cause supply of energy to radiating elements only at MSEs associated with dissipation ratios of a given range, e.g., between 0.6 and 0.9. Energy applied (emitted) to the zone at each of the subset of MSEs may be a function of the absorbable energy value at the corresponding MSE. For example, energy transmitted to the zone at MSE(i) may be a function of the absorbable energy value at MSE(i). The energy supplied to at least one radiating element (e.g., antenna 102) at each of the subset of MSEs may be a function of the absorbable energy value at each MSE (e.g., as a function of a dissipation ratio). In some embodiments, the subset of the plurality of MSEs and/or the energy transmitted to the zone at each of the subset of MSEs may be determined based on or in accordance with a result of absorbable energy information (e.g., absorbable energy feedback, which may include feedback indicative of amounts of energy absorbable by the load or object at differing MSEs) obtained during an MSE sweep (e.g., at the plurality of MSEs) on another object (e.g., benchmark object), or on the same object at an earlier time. For example, a loaf of bread may be baked in a cavity and dissipation ratio as function of MSE may be recorded. Then, another loaf of bread may be placed in a cavity of another oven, the other oven lacking the ability to measure the dissipation ratio but, including the ability to control the energy application according to the MSE dependent dissipation ratio values recorded beforehand. That is, using previously recorded absorbable energy information, the at least one processor may adjust energy supplied at each MSE such that the energy at a particular MSE may in some way be a function of an indicator of absorbable energy at that MSE. Correlations between the control parameter and an amount of energy supplied may vary depending upon application, object, and/or a desired target effect (e.g., the functional relationship may depend on the degree of uniformity of energy distribution profile required across object 11). The invention is not limited to any particular scheme, but rather may encompass any technique for controlling the energy supplied by taking into account an indication of absorbable energy or other control parameter. Some exemplary functional relationships are discussed below.

In certain embodiments, the at least one processor may be configured to cause energy to be supplied to the at least one radiating element in at least a subset of the plurality of MSEs, wherein energy transmitted (emitted) to the zone at each of the subset of MSEs is inversely related to the absorbable energy value at the corresponding MSE. Such an inverse relationship may involve a general trend—e.g., when an indicator of absorbable energy in a particular MSE subset (i.e., one or more MSEs) tends to be relatively high, the actual incident energy at that MSE subset may be relatively low. When an indicator of absorbable energy in a particular MSE subset tends to be relatively low, the incident energy may be relatively high. In some embodiments, a threshold value may be set. If the control parameter (e.g., the value indicative of absorbable energy) is above this threshold value, for example, the supplied energy is set to be smaller than if the control parameter is below the threshold.

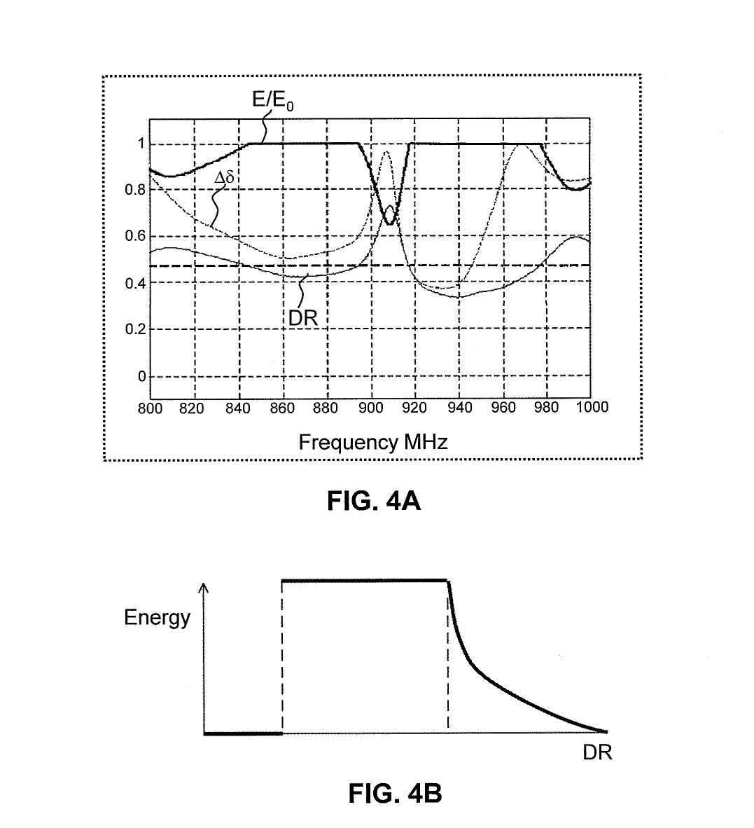

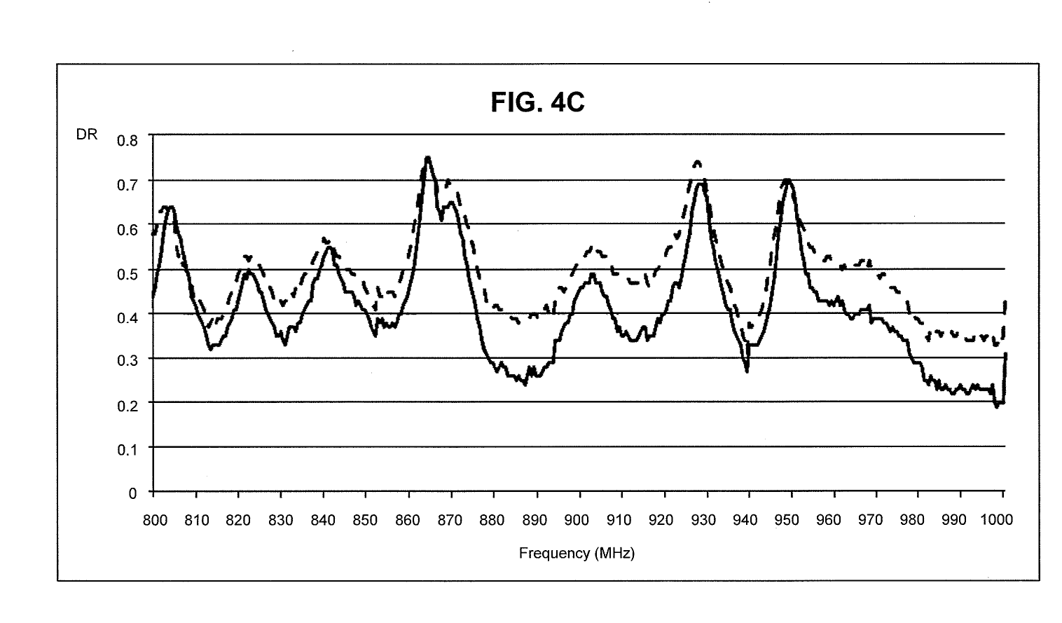

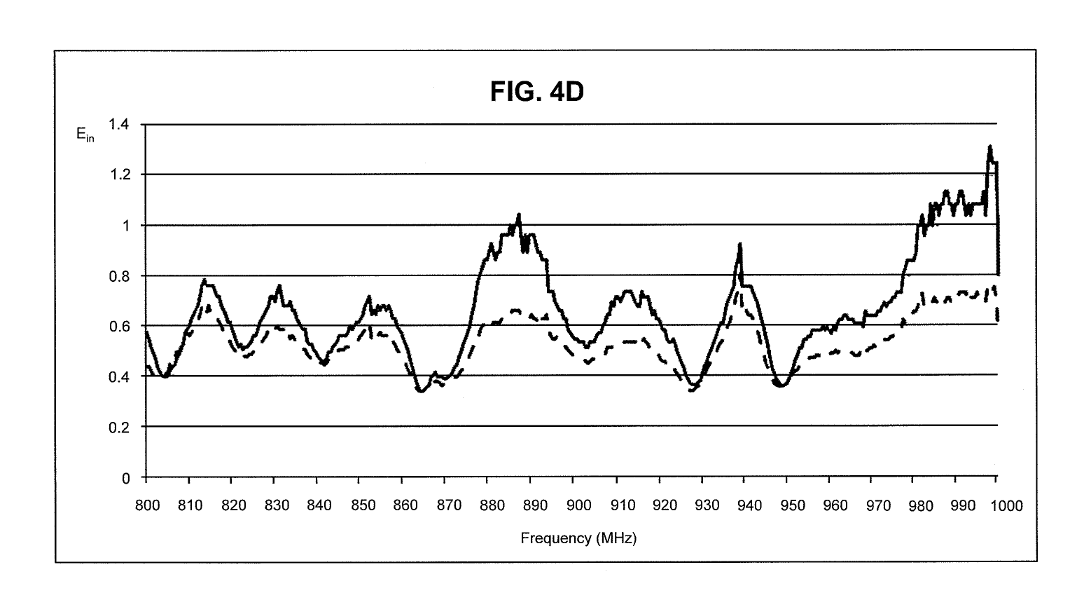

FIG. 4A shows an example of control parameters (in this case, dissipation ratios—DR and Δρ) and incident energy applied (E/E₀) against MSEs (in this case, frequencies). The incident energy E/E₀ is applied as a function of one of the control parameters (DR) according to a heating protocol of the kind depicted in FIG. 4B. In the example provided in FIG. 4A, the incident energy is essentially inversely related to the control parameter, at least over a subset of the MSEs. The inverse relationship appears where the two plots (of DR and E/E₀) tend to mirror each other, that is, in those subsets of MSEs where increase in control parameter is associated with decrease in incident energy and vice versa: decrease in control parameter is associated with increase in incident energy. These include the frequency ranges of 800-829 MHz, 900-920 MHz, and 980-1000 MHz.

This substantially inverse relationship may be even closer to accurate inversion. For example, the supplied energy may be set such that its product with the absorbable energy value (e.g., with DR or Δρ) is substantially constant across at least a subset of the applied MSEs. This subset may include, for example, MSEs, at which the control parameter is within a given range. For example, the inverse relationship may hold when the dissipation ratio is between 0.3 and 0.7, while other ratios may apply at MSEs where the dissipation ratio is smaller than 0.3 or larger than 0.7.

In some embodiments, the amount of energy applied may depend on the control parameter in different ways, or different regimes, at different ranges of the control parameter. For example, FIG. 4B, describes an exemplary heating protocol, which correlates different values of a control parameter with different amounts of energy to be supplied. As shown in FIG. 4B, energy supplied may be zero at very low dissipation ratio values, constant and high at intermediate dissipation ratio values, and inversely related to DR at high dissipation ratio values. This is only one of many possible ways by which different energy application protocols may be applied at MSEs characterized by different control parameters. Other relationships may also exist, as may be found, for example, experimentally, to bring to desired results.

In order to achieve control over the amount of energy supplied to a radiating element, e.g., antenna 102, controller 101 (or processor 2030/2030B) may be configured to hold substantially constant the amount of time at which energy is supplied at each MSE, while varying the amount of power supplied at each MSE as a function of the control parameter, e.g., the absorbable energy value. In some embodiments, controller 101 may be configured to cause the energy to be supplied to the radiating element at a particular MSE or MSEs at a power level substantially equal to a maximum power level of the device and/or the amplifier at the respective MSE(s).

Alternatively or additionally, controller 101 may be configured to vary the period of time during which energy is applied at each MSE as a function of the control parameter. At times, both the duration and power at which each MSE is applied are varied as a function of the absorbable energy value. Varying the power and/or duration of energy supplied at each MSE may be used to cause substantially uniform energy absorption in the object or to have a controlled spatial pattern of energy absorption.

In some embodiments, energy supplied at each MSE to process (e.g., cook or heat) a benchmark object may be recorded, e.g., at an object manufacturing site or a factory, and may be sent to another oven (e.g., to a memory of another oven). The other oven, which may be a feedback-free oven, may be similar to the benchmark oven, for example, in the construction of the energy oven application zone thereof. The feedback-free oven may use the recorded data to heat (or otherwise process) a target object, which may be similar to the benchmark object. Heating similar objects by similar oven with similar heating protocols may bring to similar results. The use of the recorded data may allow achieving similar results without having to actually measure the control parameter at each MSE by the feedback-free oven. The process of applying energy to a benchmark object may be referred to herein as “benchmark heating”, and the process of applying energy to a target object may be referred to herein as “target heating.”

In some embodiments, the recorded information may be sent to the feedback-free oven via a machine readable tag. For example, information regarding the benchmark heating may be encoded, and the resulting code may be transferred to a barcode or recorded in another way. The feedback-free oven may have a reader, for example a barcode reader, that reads the code. Then, the code may be decoded, for example, by a processor in the feedback-free oven, and used by the feedback-free oven for controlling the radiating elements, so as to heat a target object in target heating that is substantially the same as the benchmark heating.

In some embodiments, the recorded information may be sent to the feedback-free oven via cable, wireless, the Internet and/or other communication network. A central facility that records the information may upload it to the network (e.g., in an encoded form) and a feedback-free oven may download it.

In other embodiments, the recorded information may be programmed into the feedback-free oven. In some embodiments, information about benchmark heating process(es) may be preprogrammed (e.g., in a lookup table and/or in an algorithm), and the feedback-free oven may receive an ID of the object (e.g. from a barcode), and find in the lookup table, based on the ID, the information relevant to the correct object.

In some embodiments, a processor (e.g., in computation subsystem 96 of the feedback-free oven) may be configured to determine energy to be supplied to each radiating element based on the recorded information (e.g., the control parameter) and/or functional relationships that may be stored in the processor or in a storage space (e.g., memory) accessible to the processor. Such functional relationships may be referred to herein as “heating protocol.” One example of a heating protocol is provided in FIG. 4B, as discussed above.

Because control parameters, for example, absorbable energy, can change based on a host of factors including object temperature, in some embodiments, it may be beneficial to regularly update control parameter values and adjust energy application based on the updated control parameter. These updates can occur multiple times a second, or can occur every few seconds, or can occur more frequently than once per minute, e.g. between about 1 and about 15 times a minute, or longer, depending on the requirements of a particular application. The updates may be in accordance with information gathered before energy application began and/or before the object was placed in the energy application zone. For example, the updates may be based on measurements made with a benchmark object. This information may be encoded and associated with the object, for example, by associating to the object a machine readable element (e.g., a tag, label, or signature) that carries the encoded information. In accordance with an aspect of some embodiments of the invention, the at least one processor (e.g., controller 101 or processor 2030/2030B) may be configured to determine an amount of energy to be supplied at each of a plurality of MSEs and adjust energy supplied to the antenna at each MSE to follow a value indicative of absorbable energy or other control parameter, such that a target energy absorption level is obtained at each MSE.

Reference is now made to FIG. 5A, which provides a diagrammatic representation of an exemplary feedback-free apparatus 100 (e.g., feedback-free oven) for applying electromagnetic energy to an object, in accordance with some embodiments of the present invention. In accordance with some embodiments, apparatus 100 may include a processor 2030 which may regulate modulations performed by modulator 2014.

In some embodiments, the processor may receive information via interface 2050. In some embodiments, interface 2050 may include a keypad, a touch-screen (or other device allowing the user to manually insert the code), a barcode reader, RFID reader, or other data entry mechanism which may receive information. In some embodiments, the information may be recorded on a machine readable element of a certain kind and the interface may include a reader for the same kind of machine readable element. The machine readable element may be, for example, associated with an object to be processed or with a package of a food item to be processed (e.g., cooked). In some embodiments, the object may carry a code, for example a label with a code, and the user may enter the code via a keypad. In some embodiments, the machine readable element may carry an identifier (ID) (which may be coded or not), and the processor may be configured to use the identifier to access processing instructions and/or data indicative of such instructions. The processing instructions may have been recorded when another object (e.g., an exemplar of the object associated with the machine readable element) was processed, in another energy application zone, e.g., an energy application zone of a feedback-based apparatus.

In some embodiments, modulator 2014 may include at least one of a phase modulator, a frequency modulator, and an amplitude modulator configured to modify the phase, frequency, and amplitude of an AC waveform, respectively. Processor 2030 may alternatively or additionally regulate at least one of location, orientation, and configuration of each radiating element 2018, for example, using an electro-mechanical device. Such an electromechanical device may include a motor or other movable structure for rotating, pivoting, shifting, sliding or otherwise changing the orientation and/or location of one or more of radiating elements 2018. Alternatively or additionally, processor 2030 may be configured to regulate one or more field adjusting elements (not illustrated) located in the energy application zone, in order to change the field pattern in the zone. Alternatively or additionally, processor 2030 may be configured to change the boundary conditions (by regulating one or more boundary condition modifiers) imposed on the field in the energy application zone, and thus change the field pattern in the zone.

In some embodiments, apparatus 100 may involve the use of at least one source configured to supply electromagnetic energy to the energy application zone. By way of example, and as illustrated in FIG. 5A, the source may include one or more of an RF power supply 2012 configured to generate electromagnetic waves that carry electromagnetic energy. For example, RF power supply 2012 may be a magnetron configured to generate high power microwave waves at a predetermined wavelength or frequency. Alternatively, RF power supply 2012 may include a semiconductor oscillator, such as a voltage controlled oscillator, configured to generate AC waveforms (e.g., AC voltage or current) with a constant or varying frequency. AC waveforms may include sinusoidal waves, square waves, pulsed waves, triangular waves, or another type of waveforms with alternating polarities. Alternatively, a source of electromagnetic energy may include any other RF power supply, such as electromagnetic field generator, electromagnetic flux generator, solid state amplifier or any mechanism for generating vibrating electrons.

In some embodiments, apparatus 100 may include a phase modulator (for example, in modulator 2014) that may be controlled to perform a predetermined sequence of time delays on an AC waveform, such that the phase of the AC waveform is increased by a number of degrees (e.g., 10 degrees) for each of a series of time periods. In some embodiments, processor 2030 may dynamically and/or adaptively regulate modulation based on information gathered before energy application began, which may reach processor 2030 via interface 2050.

In some embodiments, apparatus 100 may include a frequency modulator (for example, in modulator 2014). The frequency modulator may include a semiconductor oscillator configured to generate an AC waveform oscillating at a predetermined frequency. The predetermined frequency may be in association with an input voltage, current, and/or other signal (e.g., analog or digital signals). For example, a voltage controlled oscillator may be configured to generate waveforms at frequencies proportional to the input voltage.

Processor 2030 may be configured to regulate an oscillator (not illustrated) to sequentially generate AC waveforms oscillating at various frequencies within one or more predetermined frequency bands. In some embodiments, a predetermined frequency band may include a working frequency band, and the processor may be configured to cause the transmission of energy at frequencies within a sub-portion of the working frequency band. A working frequency band may be a collection of frequencies selected because, in the aggregate, they achieve a desired goal, and there is diminished need to use other frequencies in the band if that sub-portion achieves the goal. Once a working frequency band (or subset or sub-portion thereof) is defined, the processor may sequentially apply power at each frequency in the working frequency band (or subset or sub-portion thereof). This sequential process may be referred to as “frequency sweeping.” In some embodiments, processor 2030 may be configured to select one or more frequencies from a frequency band or group of frequencies and sequentially generate AC waveforms (e.g., by regulating an oscillator) at the selected frequencies. The frequencies may be selected based on information gathered before energy application began and provided to processor 2030 (e.g., through interface 2050). Selection of frequencies may be carried out based on information read from a machine readable element, from the Internet, or received otherwise via an interface allowing receiving information from outside the apparatus.

Alternatively or additionally, processor 2030 may be further configured to regulate amplifier 2016 to adjust amounts of energy supplied to radiating elements 2018, e.g., based on information gathered before the object was placed in the energy application zone. Consistent with some embodiments, processor 2030 may be configured to cause the amount of energy supplied at a particular frequency to be low at MSEs where reflected energy and/or coupled energy have been recorded by the benchmark oven to be low. Additionally or alternatively, processor 2030 may be configured to cause one or more antennas to apply energy at a particular frequency over a short duration at an MSE where the reflected energy has been recorded to be low during benchmark heating.

In some embodiments, the apparatus may include more than one source of EM energy. For example, more than one oscillator may be used for generating AC waveforms of differing frequencies. The separately generated AC waveforms may be amplified by one or more amplifiers. Accordingly, at any given time, radiating elements 2018 may be caused to simultaneously transmit (emit) electromagnetic waves at, for example, two differing frequencies to cavity 10.

Processor 2030 may be configured to regulate the phase modulator in order to alter a phase difference between two electromagnetic waves supplied to two radiating elements in the energy application zone. In some embodiments, the source of electromagnetic energy may be configured to supply electromagnetic energy in a plurality of phases, and the processor may be configured to cause the transmission of energy at a subset of the plurality of phases. By way of example, the phase modulator may include a phase shifter (not illustrated). The phase shifter may be configured to cause a time delay in the AC waveform in a controllable manner within cavity 10, delaying the phase of an AC waveform anywhere from between 0-360 degrees.

In some embodiments, a splitter (not illustrated) may be provided in apparatus 100 to split an AC signal, for example generated by an oscillator, into two AC signals (e.g., split signals). Processor 2030 may be configured to regulate the phase shifter to sequentially cause various time delays such that the phase difference between two split signals may vary over time. The two split signals may be supplied to two radiating elements 2018. This sequential process may be referred to as “phase sweeping”. Similar to the frequency sweeping described above, phase sweeping may involve a working subset of phases selected to achieve a desired energy application goal.

The processor may be configured to regulate an amplitude modulator in order to alter an amplitude of at least one electromagnetic wave applied to the energy application zone. In some embodiments, the source of electromagnetic energy may be configured to supply electromagnetic energy in a plurality of amplitudes, and the processor may be configured to cause the emission of energy at a subset of the plurality of amplitudes. In some embodiments, the apparatus may be configured to supply electromagnetic energy to a plurality of radiating elements, and the processor may be configured to supply energy with differing amplitudes simultaneously to at least two radiating elements.

Although FIGS. 5A and 5B illustrate circuits including one or two radiating elements (e.g., radiating elements 2018), it should be noted that any suitable number of radiating elements may be employed (for example: 1, 2, 3, 4, 6, or 10), and the circuit may select combinations of MSEs through selective use of radiating elements. By way of example only, in an apparatus having three radiating elements A, B, and C, amplitude modulation may be performed with radiating elements A and B, phase modulation may be performed with radiating elements B and C, and frequency modulation may be performed with radiating elements A and C. In some embodiments amplitude may be held constant and field changes may be caused by switching between radiating elements and/or subsets of radiating elements. Further, radiating elements may include a device that causes their location or orientation to change, thereby causing field pattern changes. The combinations are virtually limitless, and the invention is not limited to any particular combination, but rather reflects the notion that field patterns may be altered by altering one or more MSEs.

Some or all of the forgoing functions and control schemes, as well as additional functions and control schemes, may be carried out, by way of example, using structures such as the electromagnetic energy application subsystems 2060 and 2060B schematically depicted in FIGS. 5A and 5B. FIG. 5B provides a diagrammatic representation of an exemplary feedback-based apparatus 100B (e.g., feedback-based oven) for applying electromagnetic energy to an object. RF power supply 2012, modulator 2014 and amplifier 2016, as well as cavity 10 and object 11 may be essentially the same as in feedback-free apparatus 100 described in the context of FIG. 5A.

In some embodiments, processor 2030B may be configured to regulate RF power supply 2012, modulator 2014, and/or amplifier 2016 to adjust energy applied via radiating elements 2018B, based on feedback signals. The feedback signals may be received, for example, from cavity 10 via radiating elements 2018B, which may be used as receiving antennas. Consistent with some embodiments, detector 2040 (which may be absent from a feedback-free apparatus such as apparatus 100 of FIG. 5A) may be provided in apparatus 100B. In some embodiments, detector 2040 may include or be a dual directional coupler connected to a radiating element. Detector 2040 may detect an amount of energy reflected from the energy application zone and/or energy emitted at a particular frequency, and processor 2030B may be configured to control RF power supply 2012, modulator 2014, and/or amplifier 2016 according to the feedback. For example, processor 2030B may be configured to cause the amount of energy applied at a particular MSE to be low when the reflected energy and/or coupled energy at the particular MSE is low. In some embodiments, processor 2030B may calculate, based on feedback received from cavity 10, a control parameter, and send operation instructions (e.g., processing instructions) to RF power supply 2012, modulator 2014, and/or amplifier 2016 based on the calculated control parameter.

In some embodiments, processor 2030B may also save some or all of the operation instructions it provides RF power supply 2012, modulator 2014, and/or amplifier 2016, to allow reproducing the very same heating sequence in absence of feedback, for example, by a feedback-free apparatus provided with the saved operating instructions. Processor 2030B, used in a feedback-based apparatus may be similar to 2030, used in a feedback-free apparatus, but in some embodiments may also deal with input from detector 2040, which may be absent from a feedback-free apparatus. Additionally or alternatively, processor 2030 may receive data from interface 2050, which may be absent from a feedback-based apparatus.

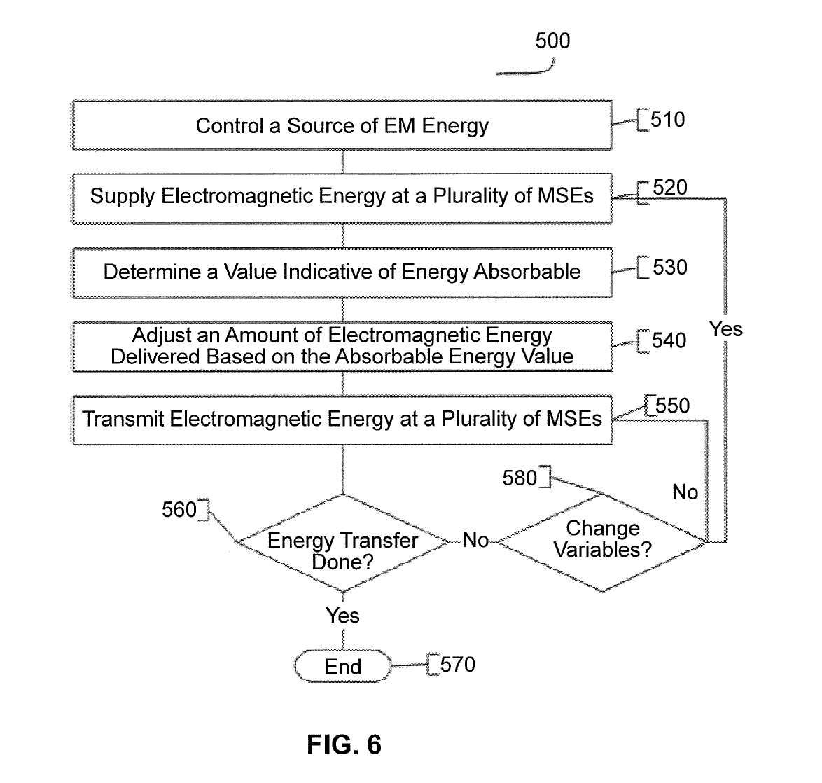

FIG. 6 represents a method for applying electromagnetic energy to a benchmark object in accordance with some embodiments of the present invention. Electromagnetic energy may be applied to a benchmark object using a feedback-based heating apparatus, for example, through at least one processor (e.g., processor 2030B or controller 101) implementing a series of steps of method 500 of FIG. 6.

The benchmark object may be an exemplar (e.g., a sample or example) of many similar objects to be processed (e.g., heated or cooked). For example, the benchmark object may be one of many loafs of not-yet-baked bread (e.g., having a defined constitution and shape). In another example, the benchmark object may be one of many green bodies of similar constitution and shape to be sintered. In another example, the benchmark object may be one of many blood products to be thawed.

In certain embodiments, method 500 may involve controlling a source of electromagnetic energy (step 510). A “source” of electromagnetic energy may include any components that are suitable for generating electromagnetic energy. By way of example only, in step 510, the at least one processor may be configured to control electromagnetic energy application subsystem 96. For example, in some embodiments, the at least one processor may be configured to control RF power supply 2012, modulator 2014, and amplifier 2016.

The source may be controlled to supply electromagnetic energy at a plurality of MSEs (e.g., at a plurality of frequencies, phases, amplitude, boundary conditions, etc.) to at least one radiating element, as indicated in step 520. Various examples of MSE supply, including sweeping, as discussed earlier, may be implemented in step 520. Alternatively or additionally, other schemes for controlling the source may be implemented so long as that scheme results in the supply of energy at a plurality of MSEs. In some embodiments, the plurality of MSEs includes a subset of two or more MSEs, each of which may excite a different wave pattern in the energy application zone. Thus, the source may be controlled to supply electromagnetic energy to excite a plurality of field patterns.

The at least one processor may regulate subsystem 96 to supply energy at multiple MSEs, which may result in multiple field patterns, to at least one transmitting radiating element (e.g., antenna 102).

In certain embodiments, the method may further involve determining a control parameter, optionally at each of the plurality of MSEs, in step 530. The control parameter may be a value indicative of energy absorbable by the object. Alternatively or additionally, the control parameter may be an MSE-dependent parameter. An absorbable energy value may include any indicator—whether calculated, measured, derived, estimated or predetermined—of an object's capacity to absorb energy. For example, computing subsystem 92 (which may include processor 2030B) may be configured to determine an absorbable energy value, such as a dissipation ratio associated with each MSE.

In certain embodiments, the method may further include receiving feedback related to the EM energy application, optionally at each of the plurality of MSEs. The feedback may be or may be used to determine the value indicative of energy absorbable by the object. The feedback may be received or determined (or calculated in any manner) at each of the plurality of MSEs supplied in step 520. A feedback may be received from the energy application zone (e.g., cavity 10) using for example detector 2040 or other sensors (e.g., sensor 20). The feedback (e.g., absorbable energy value) may include any signal related to energy applied to the zone and/or energy reflected from the zone. For example, the feedback may include: the EM energy supplied from the source to a first radiating element (acting as a transmitter), the EM energy reflected back from the energy application zone to the first radiating element, the energy coupled to at least a second radiating element located in the zone (acting as a receiver), network parameters (e.g., S parameters), the input impedance measured on one or more of the radiating elements, etc. The feedback may include any value calculated based on at least one of the received signals, for example a dissipation ration (DR or M). The Feedback may be received during the EM energy application for each of the MSEs available in an apparatus, or for a sub-group of the available MSEs. The feedback may be received (e.g., calculated based on received signals) during sweeping over a plurality of MSEs. The feedback may be received during the application of low level EM energy (e.g., at a lower power level or for shorter duration than EM energy applied in step 550). Low level EM energy may be defined as an amount of EM energy not capable of processing (e.g., heating) the object. The low level EM energy may be applied for acquiring (receiving) the feedback. Alternatively, the feedback may be received during application of EM at levels capable of processing the object.

In certain embodiments, method 500 may also involve adjusting an amount of electromagnetic energy incident or delivered at each of the plurality of MSEs based on the control parameter, for example, based on the absorbable energy value at each MSE (step 540). For example, in step 540, at least one processor may determine an amount of energy to be applied (delivered) at each MSE, as a function of the absorbable energy value associated with that MSE. In some embodiments, at least one processor may adjust EM energy application by selecting one or more MSEs (e.g., a sub-set of MSEs) based on the measured absorbable energy values (e.g., the absorbable energy value associated with that MSE).

In some embodiments, a choice may be made not to use all possible MSEs. For example, a choice may be made not to use all possible frequencies in a working band, such that the emitted frequencies are limited to a sub band of frequencies, for example, where the Q factor in that sub band is smaller than a first threshold and/or higher than a second threshold. Such a sub band may be, for example 50 MHz wide 100 MHz wide, 150 MHz wide, or even 200 MHz wide or more.

In some embodiments, the at least one processor may determine a weight, e.g., power level, used for supplying the determined amount of energy at each MSE, as a function of the absorbable energy value. For example, amplification ratio of amplifier 2016 may be changed inversely with the energy absorption characteristic of object 11 at each MSE. In some embodiments, when the amplification ratio is changed (e.g. inversely with the energy absorption characteristic), energy may be supplied for a constant amount of time at each MSE. Alternatively or additionally, the at least one processor may determine varying durations at which the energy is supplied at each MSE. For example, the duration and power may vary from one MSE to another, such that their multiplicative product correlates (e.g. inversely) with the absorption characteristics of the object. In some embodiments, the controller may use the maximum available power at each MSE, which may vary between MSEs. This variation may be taken into account when determining the respective durations at which the energy is supplied at maximum power at each MSE. In some embodiments, the at least one processor and/or controller (e.g., controller 101) may determine both the power level and time duration for supplying the energy at each MSE.

In certain embodiments, method 500 may also involve transmitting (emitting) and/or applying electromagnetic energy at a plurality of MSEs (step 550). In some embodiments, energy transmission of step 550 is at higher powers than energy supply of step 520. For example, the power supplied in step 520 may be low enough to affect only minimally, if at all, the properties of object 11. For example, the temperature of object 11 may remain unchanged after absorbing energy supplied in step 520.

Respective weights are optionally assigned to each of the MSEs to be transmitted (applied) (step 540) for example based on the absorbable energy value or other control parameter (as discussed above). Electromagnetic energy may be applied to cavity 10 via antennas, e.g., antenna 102, or 2018.

Steps 520-550 may be repeated continually during the object processing, for example, every predetermined amount of time, every time the feedback (e.g., an absorbable energy value) has changed, etc. In some embodiments, the EM energy application may be terminated based on the feedback, or based on a decision made by a user. In some embodiments, the EM energy may be terminated based on a criterion. The criterion may be, for example, a duration for which energy has been applied, a result of the energy application process, receive of a stopping order from a user, etc.

Energy application may be interrupted periodically (e.g., several times a second) for a short time (e.g., only a few milliseconds or tens of milliseconds). Once energy application is interrupted, in step 560, it may be determined if the energy transfer should be terminated. Energy application termination criteria may vary depending on application. For example, for a heating application, termination criteria may be based on time, temperature, total energy absorbable, or any other indicator that the process at issue is compete. For example, heating may be terminated when the temperature of object 11 rises to a predetermined temperature threshold. In another example, in thawing application, termination criteria may be any indication that the entire object is thawed. In other examples, heating may be terminated if a certain control parameter profile (e.g., a certain dispersion of control parameter values among MSEs) is achieved. In another example, heating may be terminated if a certain control parameter changes its time development, (e.g., if the average dissipation ratio of the object stops increasing, starts to increase, starts increasing more slowly). Thus, step 560 may include EM (e.g., RF) energy supply and control parameter determination, similarly to those described in the context of steps 520 and 530.

If, in step 560, it is determined that energy transfer should be terminated (step 560: yes), energy transfer may end in step 570.

If the criterion or criteria for termination is not met (step 560: no), it may be determined if variables should be changed and reset in step 580. If not (step 580: no), the process may return to step 550 to continue transmission of electromagnetic energy. Otherwise (step 580: yes), the process may return to step 520 to determine new variables.

For example, variables may change when the temperature of the object (or a specified portion thereof) reaches a specified value, if a certain control parameter profile was observed, if a certain time development of the total power absorbed by the object was observed or in case of other observations that may be programmed as requiring energy application adjustment.

Stopping criteria and/or variable changing criteria may be pre-programmed at the at least one processor, or may be received via an interface. For example, a user may control the operation of the heating apparatus via a GUI, and set these criteria, for example, before energy application begins and/or during energy application.

Energy application may need to be changed because of a variety of reasons. For example, after a time has lapsed, the object properties may have changed; which may or may not be related to the electromagnetic energy transmission (application). Such changes may include changes in the control parameter, and may be influenced, for example, by temperature change, translation of the object (e.g., if placed on a moving conveyor belt or on a rotating plate), change in shape (e.g., mixing, melting or deformation for any reason) or volume change (e.g., shrinkage or puffing) or water content change (e.g., drying), flow rate, change in phase of matter, chemical modification, etc. Therefore, at times, it may be desirable to change the variables of transmission, for example, to adjust the transmission to changes that occurred in the control parameter. The new variables that may be determined may include: a new set of MSEs, an amount of electromagnetic energy incident or supplied at each of the plurality of MSEs, weight, e.g., power level, of the MSE(s) and duration at which the energy is supplied at each MSE. Consistent with some of the presently disclosed embodiments, less MSEs may be swept in step 520 performed during the energy application phase than those swept in step 520 performed before the energy application phase, such that the energy application process is interrupted for a minimum amount of time.

During energy application to a benchmark object according to method 500, information regarding the amounts of energy supplied at an MSE or group of MSEs and/or other characteristics of the heating process (for example, power levels and/or energy application periods, MSEs selection) may be saved. For example, in some embodiments, measured values (e.g., values indicative of energy absorbable by the object or) during the process may be saved, for example, together with the conditions under which it was measured. For example, control parameters determined during heating may be saved, for example, together with the MSE at which that value was determined, the time at which it was measured (optionally in relation to heating application starting time). Similarly, weights duration, and/or power at which energy was delivered at each MSE may be saved, for example, at each heating cycle (e.g., weights in weighting fractions). A heating cycle may be a time lapsing between each occasion of variable change, i.e. at each occasion that “step 580: Yes” was encountered.

In some embodiments, saved information (also referred as ‘data’), e.g., saved operation parameters, may allow repeating a heating process similar or identical to that performed during the heating by the benchmark apparatus, in the absence of feedback from the energy application zone or from the object. For example, the saved operation parameters may include an amount of energy supplied to each radiating element at each MSE during each sweep. Additionally or alternatively, the time duration and power level over which energy is supplied at MSEs in each sweep may be saved. Additionally or alternatively, the control parameter (measured during each of the control parameter determining sweeps 520, 530), by which the supplied amount of energy was determined during each of the heating sweeps (550), may be saved. Additionally or alternatively, a heating protocol, by which operation parameters were determined based on the control parameters during heating, may be saved.

In some embodiments, energy application during benchmark heating may be intermittent, and the recorded operation parameters may include timing and durations of such intermissions. In some embodiments, some intermissions are reproduced when target objects are heated in absence of feedback and some are not. For example, intermissions used for measuring and calculating the control parameter during heating the benchmark object may be omitted, while intermissions making part of a heating protocol, for example, intermissions aimed at allowing heat equilibration across the object, may be reproduced.

Basic information identifying or characterizing some aspect of heating process may also be saved. For example, an ID of benchmark apparatus applied, an ID of the benchmark object heated, date, time, and place of heating, etc.

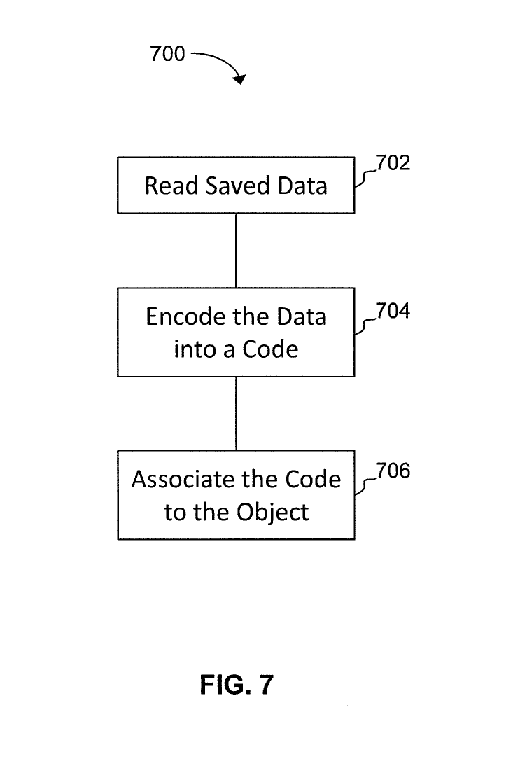

FIG. 7 is a flowchart of a method 700 for associating a target object with processing instructions in accordance with some embodiments of the invention. The method may be carried out in a central facility, for example a factory producing and/or packing the target objects, and may make use of a benchmark (feedback-based) oven, for example, through at least one processor (e.g., processor 2030B or controller 101) implementing a series of steps of method 700 of FIG. 7.

In step 702, data (information) saved during heating of a benchmark object, e.g. according with method 500, is read.

In step 704, the read data is encoded into a code; and in step 706, the code is associated with a target object.

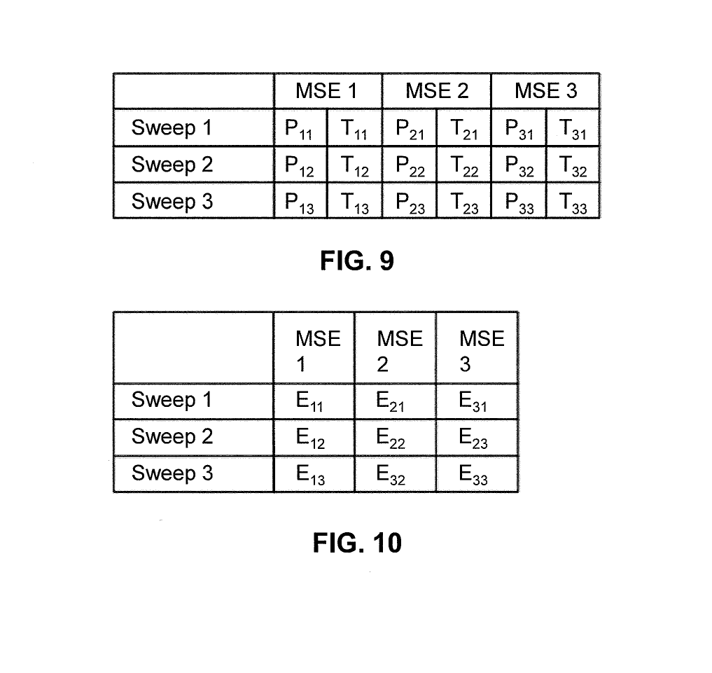

In some embodiments, saved data includes scripts of the energy application process. An exemplary script is represented by the table in FIG. 9. In the table of FIG. 9, each row includes data saved during a single energy application sweep, each column includes data pertaining to a single, defined, MSE; and each cell, defined by row and column, includes two data entries: power level (P), and energy application duration (T).

FIG. 9 shows three sweeps and three MSEs. In practice, however, a script may include hundreds, or any suitable number, of sweeps and hundreds of MSEs. For example, if a heating sequence includes 10 sweeps per second for 5 minutes it may include 3000 sweeps, and if it includes 400 frequencies (e.g. from 800 MHz to 1000 MHz at 0.5 MHz intervals), each at 8 different phases it may include 3200 MSEs.

Saved data may be less or more detailed than that shown in FIG. 9.

Power levels symbolized in FIG. 9 by the letter P and subscripts indicating the sweep and MSE numbers, may be specified by absolute values (for example: 100 W) by relative values (for example, 80% of full power), or by any other power level indications. In some embodiments (e.g., when relative values are used) the reference power level (e.g., the maximal power available to the benchmark oven at each MSE) may also be saved as part of the script or independently thereof.

In some embodiments, instead of power level and time duration the script may include amounts of energy (E, see FIG. 10). The target oven (e.g., feedback-free oven—for example: apparatus 100), using the code associated with the target object, may have autonomy to decide how much power to provide in each MSE. For example, in some embodiments, the target oven may run a self-test to determined a maximal power available to it at each MSE (Pₘₐₓ), and provide the maximal power at each MSE, or a group of MSEs, for a duration E/Pₘₐₓ. In some embodiments, the self test may be run before every heating process. In some embodiments, the self test may be run periodically, for example, once a week or once every 1000 target heating processes. In some embodiments, maximal power to be used at each frequency may be pre-programmed, and self tests may be omitted.

In some embodiments, saved data may be indicative of changes that may be expected to occur in values of one or more control parameters during heating of the target object. For example, the saved data may include values of one or more control parameters, as, for example, detected during the heating of the benchmark object. Such values may be indicative of the changes in the control parameter that may be changed during target object heating. The saved data may also include a heating protocol, by which the control parameter may be used for determining weights (e.g., amounts of energy, power levels, and/or energy application durations) to different MSEs. For example, for each sweep, the control parameter detected at each MSE may be recorded, together with the heating protocol used at that sweep. In some embodiments, one or more heating protocols may be saved on the processor of the feedback-free oven, and the data may include indication to which of these is to be used (e.g., at each sweep).

One heating protocol that may be used to determine amounts of energy to be supplied to a radiating element based on a control parameter is illustrated in FIG. 4B, where the control parameter is dissipation ratio (DR), and amounts of energy to be applied are provided as a function of the dissipation ratio. FIG. 4A shows exemplary control parameters as detected as functions of different MSEs. In FIG. 4A, the MSEs are elements of one-dimensional MS, and include frequency only. The two recorded control parameters are the dissipation ratio of the first kind (DR, full curve), and of the second kind (Dl, also referred herein as Δρ, dashed curve). The dashed straight line shows the average of DR. The figure also shows the amounts of energy to be supplied to a radiating element (e.g., the radiating element that was transmitting (emitting) when the dissipation ratio values were measured) according to a heating protocol of the kind depicted in FIG. 4B. The amounts of energy are normalized to provide values between 0 and 1. The normalizing factor (E₀) may be, for example, a maximal available power at each MSE (or group of MSEs) (e.g., in accordance with maximal available amplification of the amplifier at each MSE). In this case, the normalizing factor may be MSE dependent, and the “normalized” value may represent time durations for supplying maximal power to the radiating element.

FIG. 4C shows graphs of a dissipation ratio (DR) measured during heating of a pizza in a feedback-based oven. The full line shows data collected one minute after heating started, and the dashed line shows data collected one minute later. FIG. 4D shows energy that may be provided by a feedback-free oven that follows these changes in the dissipation ratio, for example, during heating of an exemplar of the pizza. The units of Eᵢₙ in FIG. 4D may be arbitrary. The full line shows energy to be supplied one minute from beginning of heating, and the dashed line shows energy to be supplied one minute later.

Between the two sweeps (represented by full and dashed lines), the DR maintained its general shape, and had peaks and deeps at substantially the same frequencies. However, DR was generally larger at the later sweep (dashed line). This may be followed in a feedback-free oven by maintaining the peaks and deeps in the supplied energy (Eᵢₙ) at substantially the same frequencies, and generally supplying less energy at the latter sweep, as depicted in FIG. 4D. In fact, the Eᵢₙ line tends to mirror the DR line both at 1 minute and at 2 minutes from heating commencement. This is another possible indication to the changes in DR being followed by the feedback-free oven. A closer analysis of the data presented in FIGS. 4C and 4D show that the DR measured by the feedback-based oven (FIG. 4C) multiplied by the energy supplied by the feedback-free oven (FIG. 4D) is substantially constant over the entire range of frequency both at 1 minute and 2 minutes. This may be another indication to the changes in DR being followed by the feedback-free oven. The product of the multiplication is also substantially the same (about 0.25 absorbed energy units, in the arbitrary units used in FIG. 4D). This may be another indication to the following of the changes in DR by the feedback-free oven. These are just few examples of how energy supplied (to a radiating element) may follow changes in a control parameter, and the invention is not limited by these examples, and may be practiced by following mechanisms that result in different indicators to the following.

Computing sub-system 92 (FIG. 1) may calculate amounts of energy to be applied at each MSE during a single MSE sweep. This may result in a curve such as depicted with a thick curve in FIG. 4A, in curves as depicted in FIG. 4D, or the like. For example, using the information recorded in FIGS. 4A (thin curves) and 4B the computing sub-system 92 may find the value of the control parameter at each frequency and determine the amount of energy to be supplied at that value of control parameter, thus determining an amount of energy to supply at each frequency. For example, computing subsystem 92 may find in FIG. 4A the DR value at 900 MHz (˜0.55), and determine base on FIG. 4B (or any other representation of the data presented in the figure, e.g., in a lookup table), the amount of energy to be applied at 900 MHz based on the DR value measured at that frequency. Optionally, pairs of graphs of energy vs. control parameter and control parameter vs. MSE may be provided for a heating process, for example, one pair of graphs for each MSE sweep.

In some embodiments, after data is read (step 702), the read data may be encoded into machine-readable symbols.

The encoding process may include compressing the data. For example, the data may be compressed by including only changes in supplied energies. For example, for the first sweep all the energies may be included in the compressed script, and for the second sweep, MSEs that supply the same amount of energy as in the first sweep are excluded, and only those that provide different amounts of energy are included in the script.

Encoding may include replacing sets of values with references to lookup tables that include similar or identical values. The lookup tables may be given in advance, and coding may include choosing between given lookup tables the ones that are most suitable for reproducing the successful heating process.

For example, in some embodiments, some predetermined sweeps may be saved (e.g. pre-programmed) on target apparatuses, and the data obtained from the benchmark apparatus are encoded into pointers that point to places in the memory of the target apparatus, where the appropriate script is saved. For example, scripts for cooking certain products may be saved as described in relation to FIG. 6, and preprogrammed to target ovens, where they are saved under some ID address. In such a case, the encoding of the script may include preparing a barcode or other machine readable element that carries the ID.

The code may be digital (for example, a barcode), analog, visual (for example, an image), or include any other kind of data or format. The kind of code may be selected according to the amount and nature of information to be coded. For example, if encoding only an ID may be sufficient, different images may code different IDs, if full scripts are to be encoded, other data carriers may be used, for example, barcodes or other machine readable elements.

The encoded information may be embedded on a machine readable element in any method known in the art of encoding information into machine readable elements. For example, the encoded information may be represented digitally as zeroes and ones, which may be represented as bars on a barcode. In some embodiments, the coded information may be carried on a memory device (for example a flash-USB device of the kind known as disk-on-key). The memory device may be packed together with the target object or may be supplied separately.

In step 706, the machine readable element may be associated with the target object. For example, the machine readable element may be attached to a package of the target object and/or may be embedded in the target object.

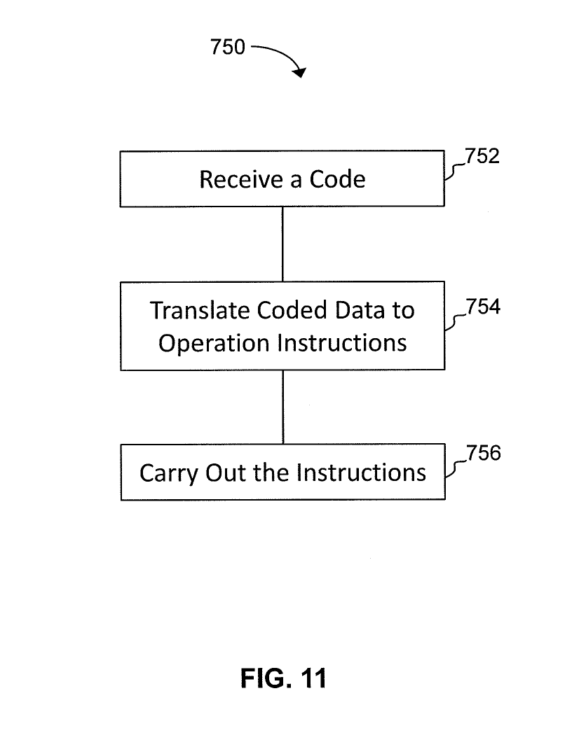

FIG. 11 is a flowchart of a method 750 of heating a target object in a feedback-free heating apparatus according to some embodiments of the invention. The method may be carried out in a restaurant or at home and may make use of a feedback-free oven (e.g., apparatus 100). The method may be carried out through implementation of a series of steps of method 750 of FIG. 11 using at least one processor (e.g., processor 2030 or controller 101).

At step 752, a code may be received via an interface. At step 754 the code may be decoded, and translated into operation instructions, and at 756 the instructions are carried out.

Receiving the code via the interface (step 752) may include, for example, reading a machine readable element (e.g. a barcode for example such as a two-dimensional barcode) or an RFID tag. Additionally or alternatively, receiving the code may include receiving from a user interface. For example, the code may be a 4-digit number, and a user may type the number with a keypad that makes part of the interface. In another example, receiving may include imaging with a CCD or other imaging device.

Decoding the received code (step 754) may depend on the way the information was encoded at first place. Thus, decoding may include, for example, identifying a detail in an image and finding in a lookup table an ID associated with the detail, expanding a compressed script, or any other way by which the encoded information may be decoded.

Carrying out the instructions (step 756) may include supplying energy to one or more radiating elements, controlling position, location, and/or orientation of radiating elements, controlling boundary conditions modifiers, or any other action that took place during the heating in the benchmark oven. In some embodiments, carrying out the instructions results in following changes in a control parameter not measured during the heating process.

The changes in the control parameter may include changes along a timeline and/or changes along MSE-line. For example, the control parameter may change from one MSE to another, and the processor may adjust energy supply to follow this change. In another example, the control parameter may change, even in respect of a single MSE, during the heating process, and the processor may be configured to adjust energy supply to follow this change. In some embodiments, both timeline changes and changes along MSE line exist and are being followed.

Fulfilling some conditions may facilitate the following of the control parameter. First, the target object should be similar to the benchmark object. For example, if a script that was developed while following changes in the control parameter when a steak was prepared is used for cooking a cake, changes in the control parameter may not be followed. Second, the cavity of the heating apparatus (see part 10 in FIGS. 5A and 5B, and part 9 in FIG. 1) should be similar (e.g., in shape, antenna type and position within the cavity), because providing energy at the same MSE, for example, at the same frequency, at two different cavities may result in two different control parameters (e.g., in different dissipation ratios), even if the target object and the benchmark object are identical. Third, it may be helpful for the target object and the benchmark object to be put in the same or similar place, position, and orientation during target heating and benchmark heating. For example, the change in a control parameter may depend on the object orientation in the oven if, for example, the object includes portions of different chemical composition.

As noted above, in some embodiments, the processor may be configured to adjust amounts of energy supplied (“the supplied amounts”) to at least one of the radiating elements, such that the supplied amounts follow changes in a control parameter.

In some embodiments, the supplied amounts may be considered as following a control parameter or changes in a control parameter, if the supplied amount is a univalent function of the control parameter during at least one MSE sweep. In some embodiments, the function is similar in two or more of the sweeps, in some—in a majority of the sweeps, and in some—in all the sweeps. The supplied amounts may be a univalent function of the control parameter if whenever the control parameter is the same, so is the supplied amount (at least within some tolerance, which may be, for example, smaller than 20%, 10% or 5%). However, the same supplied amount of energy may be provided at different values of the control parameter, as may be evident, for example, by the horizontal lines making part of the univalent function illustrated in FIG. 4B.

In some embodiments, the data encoded on the machine readable element (or otherwise communicated to the processor) may include amounts of energy to be supplied to one or more of the radiating elements at each MSE during each sweep. In such a case, it may be that no value indicative of the control parameter is provided to the apparatus, and still, the processor may adjust the supplied amounts of energy such that changes in the control parameter are followed.

In some embodiments, the control parameter may be a parameter that depends on amounts of energy supplied to a radiating element in the energy application zone (I) and amounts of energy reflected back to the radiating element (R). For example, the control parameter may be the ratio between the two amounts of energy (e.g., R/I). Additionally or alternatively, the control parameter may depend on amounts of energy coupled to one or more other radiating elements (T). Thus, the control parameter may be, for example, T/I, T/(I−R), (I−R−T)/I, (I−R−T)/(I−R), or any other combination of the three amounts of energy: I, T, and R. In some embodiments, the control parameter may depend on (or be equal to) a matching parameter (antenna input impedance—Zᵢₙ), its real part (Re(Zᵢₙ)), or its imaginary part (Im(Zᵢₙ)).

In some embodiments, the control parameter may determine only whether energy is supplied to the radiating element at a given MSE or not. For example, in one such embodiment, when the dissipation ratio is larger than a threshold, energy is supplied. Otherwise—energy may not be supplied.

In some embodiments, the control parameter may also determine the amount of energy supplied. For example, in some embodiments, the energy supply at each MSE may be proportional to the control parameter in that MSE. In some embodiments, the energy supply may be inversely related to the control parameter. In some embodiments, different relationships may be between the control parameter and the supplied amount of energy at different ranges of the control parameter.

In some embodiments, the energy supplied to each of the radiating elements may be different. For example, the energy supplied to each of the radiating elements may follow its own control parameter. The amount of energy coupled from radiating element A to radiating element B may be different from the amount of energy coupled from radiating element B to radiating element A even if the energy supplied to the two radiating elements is the same. This may be due to, for example, an object that absorbs more of the energy supplied by one of the radiating elements than energy supplied by the other one. Thus, the dissipation ratio (or any other control parameter) that is followed by energy supplied to one of the radiating elements may be different from that followed by energy supplied to another of the radiating elements.

In some embodiments, the apparatus may include a positioning element, for positioning the object in a predefined position in the energy application zone during energy application. For example the positioning element may include a pair of trails that the object fit, in between. A positioning element may facilitate the heating of the object when it is in the same position as the benchmark object has been during benchmark heating.

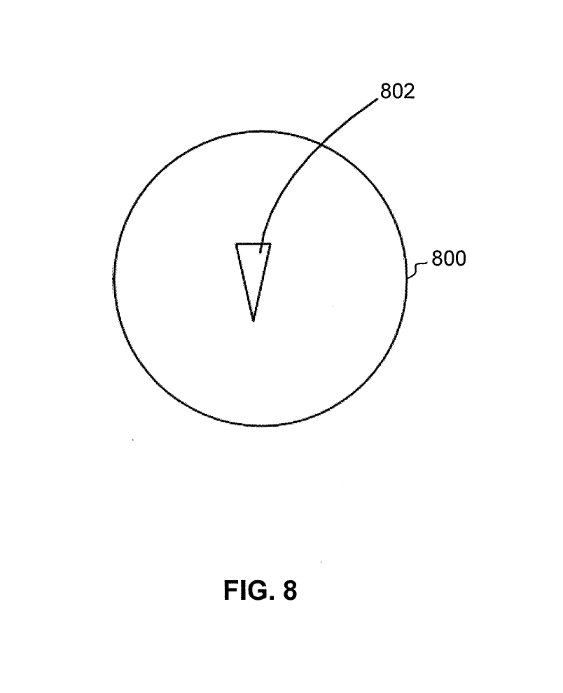

FIG. 8 diagrammatically illustrates a positioning element in the form of a turntable 800 which may be included in cavity 10 or energy application zone 9, shown in FIG. 1, according to some embodiments of the invention. Turntable 800 may include a positioning element 802, for example, having a triangular cross-section. The positioning element may be a protrusion or a recess. Object 11, shown in FIG. 1, may have a corresponding positioning feature (not shown), in the form of a recess (or protrusion) of the same cross section. Thus, object 11 may be stable on the turntable only if positioning element 802 fits the positioning feature on object 11. Accordingly, if the object is stable on the turntable, it its position and orientation in respect of positioning element 802 may be known. In some embodiments, the positioning element may include recessed portions in a tray or other component in the energy application zone, and the object may include protrusions. In some embodiments, the energy application zone may include one or more magnets that attract one or more ferromagnetic portions on the object to position the object in a predetermined manner in the energy application zone.

In some embodiments of the invention, the processor may be configured to receive data from a user, and use this data together with information gathered before the object was placed in the energy application zone. For example, data provided by the user may determine when to stop the energy application process. In another example, the data provided by the user may be indicative for the need to run one of several available heating processes. For example, an object may be associated with a machine readable tag that includes defrosting instructions and cooking instructions, and the user may provide input, by which the processor may decide which process to run. In another example, the information gathered before the object was placed in the energy application zone may include indications of temperatures of the object at different stages of the processing. User provided data may be indicative of the initial temperature of the object and/or of the final desired temperature of the object, and the processor may run the appropriate portions of the energy application procedure as provided by the information based on the predetermined data.

In another example, the information gathered may include operation instructions suitable for achieving several different results (e.g., four levels of cooking a steak, for example: rare, medium-rare, medium, and well-done). The user may provide the desired result (for example: medium), and the processor may execute the operation instructions until the desired result is achieved, and then stop the processing. In some embodiments, the information gathered beforehand may include indications on when to stop energy application to achieve each of several possible target degree of doneness. In some embodiments, the controller may be preprogrammed with a total amount of energy to be absorbed by a food object (e.g., steak, of a given weight in order to obtain each target level of cooking) and the processor may use the recorded information in order to calculate when the right amount of energy has been absorbed, and subsequently stop the process. In such embodiments it may be advantageous if the apparatus is equipped with weight for measuring the weight of the steak, or if the interface allows the user to enter the weight of the steak, or if the machine readable element is provided with the weight of the steak.

“Following changes” or “tracking changes” in a control parameter may include other, more complex relationships between changes in a control parameter and in the supplied energy. For example, at some range of the control parameter the supplied energy may be independent of the value of the control parameter. In other ranges, the supplied energy may change inversely with the control parameter. Generally, different energy application protocols may be applied at different ranges of the control parameter. In some embodiments, three or more ranges of control parameters may be defined and each may be associated with a different energy application protocol.

In some embodiments, energy may be applied at two or more frequencies, for example, over a range of frequencies. Additionally or alternatively, energy may be applied by two or more radiating elements, at two or more different time-phase differences between them. Additionally or alternatively, energy may be applied by two or more radiating elements at different amplitude differences between them. More generally put, the energy may be applied at different modulation space elements (MSEs), each of which being a set of values of parameters, which together determine a field pattern excited in the energy application zone when energy is applied at the MSE. Each of the parameters, the values of which form together the MSE may be controllable by the apparatus.

In some embodiments, the control parameter may relate to the value of one or more MSEs. For example, a control parameter may be a univalent function of an MSE or series of MSEs. In some embodiments, the MSE dependent control parameter may be the ratio between supplied power and reflected power different MSEs (e.g., at different frequencies). Thus, the control parameter may differ from one frequency to another (and, more generally put, from one MSE to another). The control parameter may also change differently at different MSEs, for example, it may increase at one frequency and decrease at another. Consequently, the changes in amounts of energy supplied to the radiating element may differ from one MSE to another. For example, it may happen that during a single MSE scan more energy will be supplied at one MSE than in a previous scan, and less energy will be supplied at a second MSE than in the previous scan.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment of the invention. Moreover, it will be apparent to those skilled in the art from consideration of the specification and practice of the present disclosure that various modifications and variations can be made to the disclosed embodiments without departing from the scope of the invention. For example, one or more steps of a method and/or one or more components of an apparatus or a device may be omitted, changed, or substituted, e.g., with a step or component described in the context of another embodiment, without departing from the scope of the invention. Thus, it is intended that the specification and examples be considered as exemplary only, with a true scope of the present disclosure being indicated by the following claims and their equivalents.

1-20. (canceled)

21. A method for allowing an apparatus suitable for applying RF energy to an object in a cavity at a plurality of frequencies to heat an object in the cavity according to changes in a control parameter, in absence of feedback regarding the control parameter, the method comprising:
heating, in a first apparatus suitable for applying RF energy to an object in a cavity at a plurality of frequencies, a first object with RF energy according to feedback regarding the frequency dependent control parameter;
recording information regarding the heating process, wherein the recorded information is sufficient to substantially reproduce the heating process in absence of feedback regarding the frequency dependent control parameter; and
allowing a second apparatus suitable for applying RF energy to an object in a cavity at a plurality of frequencies to access the recorded information.

22. A method according to claim 21, wherein allowing a second apparatus to access the recorded information comprises recording the information to a machine readable element.

23. A method according to claim 21, wherein allowing a second apparatus access to the recorded information comprises storing the information on a storage device, and recording on a machine readable element data that allows access to the information on the storage device.

24. The method of claim 21, wherein substantially reproducing the heating process comprises adjusting energy supplied to at least one radiating element twice or more during energy application.

25. The method of claim 21, wherein substantially reproducing the heating process comprises adjusting the energy supplied to at least one radiating element more frequently than once per minute.

26. A method according to claim 21, wherein heating according to feedback regarding a frequency dependent control parameter comprises adjusting supplied amounts of energy to vary inversely with a dissipation ratio over a range of frequencies, phase differences, and/or amplitude differences.

27. A method according to claim 21, wherein the frequency-dependent parameter relates to amounts of coupled energies, coupled between two radiating elements used for applying RF energy to the object in the apparatus.

28. A method according to claim 21, wherein heating according to feedback regarding a frequency dependent control parameter comprises selecting amounts of energy applied at each frequency, phase difference, and/or amplitude difference from a group comprising three or more energy amount values.

29. A packaged product, comprising:
a first food item packed for consumer use; and
a machine readable element associated with the first food item,
wherein the machine readable element allows access to data that enables applying radio frequency (RF) energy to the first food item in a manner that follows changes in a frequency-dependent control parameter, wherein the data have been collected when a second food item was cooked by RF energy at multiple frequencies, phase differences, and/or amplitude differences.

30. A packaged product according to claim 29, wherein the machine readable element allows access to the data to a first apparatus, and the data has been collected when the second food item was cooked in a second apparatus.

31. A packaged product according to claim 29, wherein the machine readable element carries the data.

32. A packaged product according to claim 29, wherein the machine readable element carries information that allows access to the data on a storage device.

33. A packaged product according to claim 29, wherein the data is indicative of weights to be associated with different frequencies, phase differences, and/or amplitude differences in a heating process of the first food item.

34. A packaged product according to claim 29, wherein the data is indicative of weights associated with different frequencies, phase differences, and/or amplitude differences in a heating process of a second food item.

35. A packaged product according to claim 29, wherein the data have been collected when the second food item was cooked at multiple frequencies, phase differences, and/or amplitude differences in presence of feedback regarding the control parameter.

36. A packaged product according to claim 29, wherein the control parameter is MSE frequency dependent.

37. A packaged product according to claim 29, wherein the control parameter is a dissipation ratio.

38. A packaged product according to claim 29, wherein the machine readable element includes a tag affixed to the packaged product.

39. A system comprising an apparatus for applying RF energy to an object, and an object, wherein
the object is associated with a code; and
the apparatus includes an interface for receiving the code and a processor configured to decode the code to operation instructions of the apparatus,
wherein the operation instructions are such that when carried out, changes that occur in a control parameter during the operation are followed in absence of feedback regarding the changes.

40. (canceled)

41. A system according to claim 39, wherein the object is a packaged product including a first food item packed for consumer use; and
a machine readable element associated with the first food item,
wherein the machine readable element allows access to data that enables applying radio frequency (RF) energy to the first food item in a manner that follows changes in a frequency-dependent control parameter, wherein the data have been collected when a second food item was cooked by RF energy at multiple frequencies, phase differences, and/or amplitude differences.
